(19) United States
(12) Patent Application Publication
(10) Pub. No.: US 2026/0059395 A1
(43) Pub. Date: Feb. 26, 2026

(54) SYSTEMS AND METHODS FOR HANDOVER SIGNALING REDUCTION

(71) Applicant: APPLE INC., Cupertino, CA (US)

(72) Inventors: Fangli Xu, Beijing (CN); Haijing Hu, Los Gatos, CA (US); Ralf Rossbach, Munich (DE); Naveen Kumar R Palle Venkata, San Diego, CA (US); Alexander Sirotkin, Hod Hasharon (IL); Ping-Heng Kuo, London (GB); Peng Cheng, Beijing (CN); Dawei Zhang, Saratoga, CA (US); Sethuraman Gurumoorthy, San Ramon, CA (US)

(21) Appl. No.: 18/997,581

(22) PCT Filed: Aug. 8, 2022
(86) PCT No.: PCT/CN2022/110824

§ 371 Date: Jan. 22, 2025

(51) Int. Cl. H04W 36/00; H04L 1/1812; H04L 5/00; H04W 36/08; H04W 76/27

(52) U.S. Cl. CPC H04W 36/0055; H04L 1/1812; H04L 5/0055; H04W 36/08; H04W 76/27

(57) ABSTRACT

Systems and methods discussed herein relate to handover signaling reduction in the cases where one or more user equipments (UEs) are to be handed over from a source serving cell of a source base station to a target serving cell of a target base station based on common configuration information for operating on the target serving cell and dedicated configuration information for each specific UE. In various cases, a point-to-multipoint (PTM) transmission includes the common configuration information for the UEs, a handover command instructs a UE to independently acquire common configuration information from system information blocks (SIBs) of the target serving cell, or a handover command for a UE indicates that the UE is to re-use a common configuration for the source serving cell. Handover commands may be used to provide dedicated configuration information for each UE. Configuration related communications sent on Xn and F1 interfaces are also discussed.

### TECHNICAL FIELD

This application relates generally to wireless communication systems, including wireless communication systems implementing non-terrestrial network (NTN) communication mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 502.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates a diagram for comparing terrestrial cell characteristics and NTN cell characteristics.

FIG. 3 illustrates a table of NTN conditional handover conditions, according to embodiments herein.

FIG. 4 illustrates various definitions for NTN conditional handover conditions, according to embodiments herein.

FIG. 5 illustrates a diagram illustrating a handover scenario for an NTN cell, according to an embodiment.

FIG. 6 illustrates a flow diagram for a framework for the separate treatment of common configuration information and dedicated configuration information, according to embodiments herein.

FIG. 7 illustrates a flow diagram for the provision of common configuration information for operating on a target serving cell in a broadcast or PTM manner, according to an embodiment.

FIG. 8 illustrates a PDCP PDU format for a PTM transmission, according to embodiments herein.

FIG. 9 illustrates a flow diagram for the provision of common configuration information for operating on a target serving cell in a broadcast or PTM manner, according to an embodiment.

FIG. 10 illustrates a flow diagram for the provision of common configuration information for operating on a target serving cell in a broadcast or PTM manner, according to an embodiment.

FIG. 11 illustrates a flow diagram for UE acquisition of common configuration information, according to an embodiment.

FIG. 12 illustrates a flow diagram for UE acquisition of common configuration information, according to an embodiment.

FIG. 13 illustrates a flow diagram a first case for re-use of a common configuration for a source serving cell for a handover to a target serving cell, according to an embodiment.

FIG. 14 illustrates a flow diagram a second case for re-use of a common configuration for a source serving cell for a handover to a target serving cell, according to an embodiment.

FIG. 15 illustrates a flow diagram for a first option for providing dedicated configuration information to a UE.

FIG. 16 illustrates a flow diagram for a second option for providing dedicated configuration information to a UE.

FIG. 17 illustrates a flow diagram for a third option for providing dedicated configuration information to a UE.

FIG. 18 illustrates the use of a group handover command attendant to performing handover of a group of UEs.

FIG. 19 illustrates a method of a UE, according to embodiments herein.

FIG. 20 illustrates a method of a source base station, according to embodiments herein.

FIG. 21 illustrates a method of a UE, according to embodiments herein.

FIG. 22 illustrates a method of a source base station, according to embodiments herein.

FIG. 23 illustrates a method of a UE, according to embodiments herein.

FIG. 24 illustrates a method of a UE, according to embodiments herein.

FIG. 25 illustrates a method of a source base station, according to embodiments herein.

FIG. 26 illustrates a diagram for a first option for communicating a common configuration between a source base station and a target base station on an Xn interface, according to an embodiment.

FIG. 27 illustrates a diagram for a second option for communicating a common configuration between a source base station and a target base station on an Xn interface, according to an embodiment.

FIG. 28 illustrates a diagram for a third option for communicating a common configuration between a source base station and a target base station on an Xn interface, according to an embodiment.

FIG. 29 illustrates a diagram for a fourth option for communicating a common configuration between a source base station and a target base station on an Xn interface, according to an embodiment.

FIG. 30 illustrates a diagram for a fifth option for communicating a common configuration between a source base station and a target base station, according to an embodiment.

FIG. 31 illustrates a flow diagram for group-wise configuration for multiple UEs between a target-DU and a CU on an Fl interface, according to an embodiment.

FIG. 32 illustrates a method of a source base station, according to embodiments herein.

FIG. 33 illustrates a method of a target base station, according to embodiments herein.

FIG. 34 illustrates a method of a source base station, according to embodiments herein.

FIG. 35 illustrates a method of a source base station, according to embodiments herein.

FIG. 36 illustrates a method of a target base station, according to embodiments herein.

FIG. 37 illustrates a method of a source base station, according to embodiments herein.

FIG. 38 illustrates a method of a target base station, according to embodiments herein.

FIG. 39 illustrates a method of a DU, according to embodiments herein.

FIG. 40 illustrates a method of a CU, according to embodiments herein.

FIG. 41 illustrates an example architecture of a wireless communication system, according to embodiments disclosed herein.

FIG. 42 illustrates a system for performing signaling between a wireless device and a RAN device connected to a core network of a CN device, according to embodiments herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network.

Therefore, the UE as described herein is used to represent any appropriate electronic component.

Non-terrestrial networks (NTNs) refer to networks (or segments of networks) using airborne and/or space-borne vehicle(s) to perform communications.

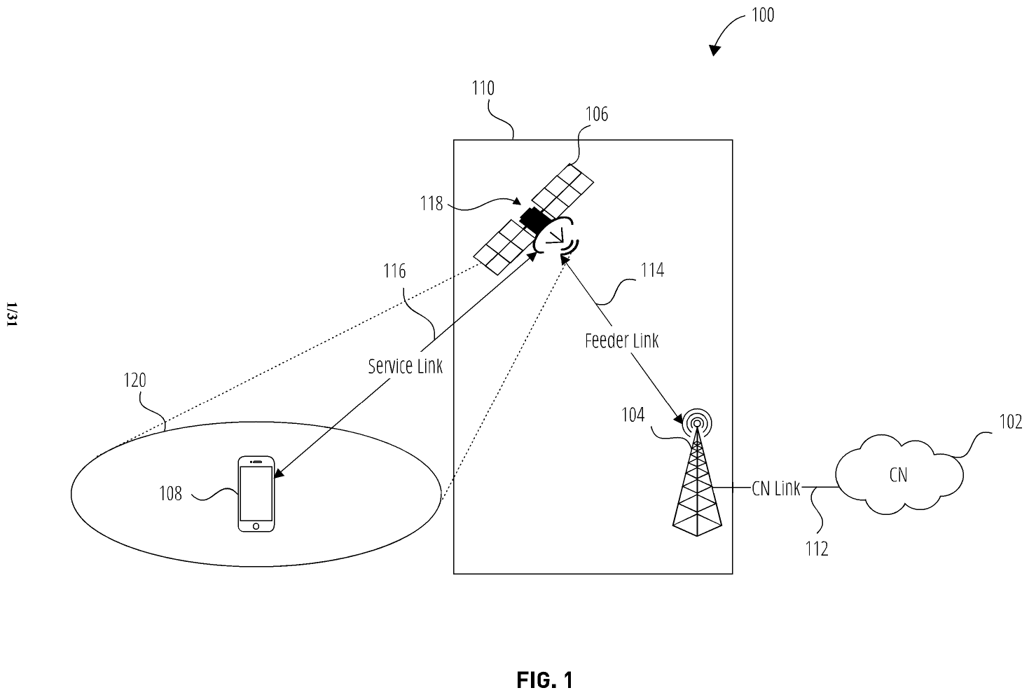

FIG. 1 illustrates an NTN architecture 100 of a wireless communication system, according to an embodiment. The NTN architecture 100 includes a core network (CN) 102, a base station 104, a vehicle 106 having a payload 118, and a UE 108. The base station 104, and the payload 118 of the vehicle 106 may be included in a RAN 110.

In some embodiments, RAN 110 includes NG-RAN, the CN 102 includes a 5GC, and the base station 104 includes a gNB or a next generation eNB (ng-eNB). In such cases, the CN link 112 connecting the CN 102 and the base station 104 may include an NG interface.

In the NTN architecture 100, the payload 118 of the vehicle 106 is a network node of the RAN 110. The payload 118 may be equipped with one or more antennas capable of operating (e.g., broadcasting, facilitating communications of, etc.) a cell 120 of the RAN 110 as instructed/configured by the base station 104. The base station 104 communicates (e.g., via a non-terrestrial gateway (not shown)) with the payload 118 of the vehicle 106 over a feeder link 114. The UE 108 may be equipped with one or more antennas (e.g., a moving parabolic antenna, an omni-directional phased-array antenna, etc.) capable of communicating with the payload 118 via a Uu interface on a cell 120 of the RAN over a service link 116. Herein cells (such as the cell 120) that are provided by a payload of an NTN vehicle may be referred to as “NTN cells.” It is also noted that a payload of an NTN may be sometimes referred to herein as an “NTN payload.”

The NTN architecture 100 illustrates a “bent-pipe” or “transparent” satellite based architecture. In such systems, the payload 118 transparently forwards data between the base station 104 and the UE 108 using the feeder link 114 between the base station 104 and the payload 118 and the service link 116 between the payload 118 and the UE 108. The payload 118 may perform radio frequency (RF) conversion and/or amplification in both uplink (UL) and downlink (DL) to enable this communication.

In the embodiment shown in FIG. 1, the base station 104 is illustrated without the (express) capability of terrestrial wireless communication directly with a UE. However, it is contemplated that in embodiments, such a base station using a non-terrestrial gateway to communicate with the payload 118 could (also) have this functionality (either with the UE 108 or with another (unillustrated) UE).

The NTN architecture 100 illustrates a vehicle 106 that is a space-borne satellite. In such cases, it may be that the vehicle 106 is a low earth orbit (LEO) satellite, a medium earth orbit (MEO) satellite, a geosynchronous earth orbit (GEO) satellite, or a high earth orbit (HEO) satellite. It is also noted that vehicles other than satellites may be used in NTNs. For example, the vehicle 106 could instead be a high altitude platform station (HAPS) (such as, for example, an airship or an airplane).

In some cases, NTNs may be useful to address mobile broadband needs and/or public safety needs in areas that are unserved/underserved by terrestrial-based network elements. Some such example cases include maritime applications, airplane connectivity applications, railway applications, etc.

It may be that in some cases an NTN supports/uses, for example, LEOs and GEOs, with further implicit compatibility for supporting HAPSs and air-to-ground (ATG) scenarios. Further, an NTN may focus on frequency division duplex (FDD) mechanisms, with time division duplex (TDD) mechanisms being applied for relevant scenarios, such as for HAPS, ATG, etc.

Some NTNs may use earth-fixed tracking areas for a defined areas that do not change corresponding to any movement of a payload of the NTN.

It may also be that UEs have the capability of determining their own location (e.g., via global navigation satellite systems (GNSSs) such as global positioning system (GPS), Galileo GNSS, etc.) and further of communicating that location information to the base station (e.g., via a payload).

UE that may be used in NTNs may include, but are not limited to, handheld devices operating in FR1 (e.g., power class 3 devices) and/or very small aperture terminal (VSAT) devices with external antenna at least in FR2.

It is contemplated that the coverage of a cell (or a beam of a cell) broadcast by an NTN vehicle may be relatively larger than a coverage of a cell (or a beam of a cell) that is broadcast by a terrestrial RAN element. In some cases, the coverage of a single NTN cell may be across multiple countries, states, etc.

In some NTN systems, UE handover (HO) mechanisms may operate according to some restrictions. For example, in such systems, it may be that a UE is not required to connect to both an NTN cell and a terrestrial cell simultaneously during HO. Further, in such cases, it may be that the use of dual active protocol stack (DAPS) is not supported.

Herein conditional handover (CHO) is discussed. In some cases, conditional handover conditions may be introduced for NTN specific conditional handover due to particular NTN radio characteristics.

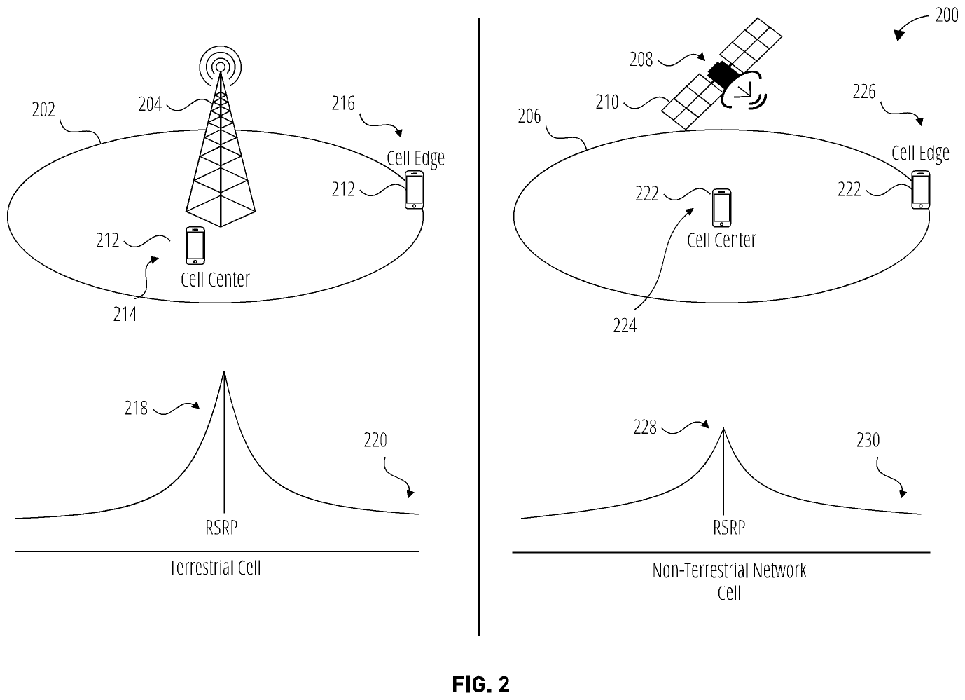

FIG. 2 illustrates a diagram 200 for comparing terrestrial cell characteristics and NTN cell characteristics. The diagram 200 illustrates a terrestrial cell 202 that is broadcast by a terrestrial base station 204 and an NTN cell 206 that is broadcast by a payload 208 of a satellite 210.

The UE 212 operates in the terrestrial cell 202. When the UE 212 is at the cell center 214, it may experience a higher relative reference signal received power (RSRP) 218. As the UE 212 moves to the cell edge 216, it may experience a lower relative RSRP 220 that is lower than the higher relative RSRP 218 due to its increased distance from the terrestrial base station 204.

The UE 222 operates in the NTN cell 206. When the UE 222 is at the cell center 224, it may experience a higher relative RSRP 228. As the UE 222 moves to the cell edge 226, it may experience a lower relative RSRP 230 that is lower than the higher relative RSRP 228 due to its increased distance from the payload 208.

As can be seen with reference to the diagram 200, the variation in RSRP between a cell center and a cell edge is not as pronounced in the case of an NTN cell as compared to a cell broadcast by terrestrial based equipment. Accordingly, NTN specific conditional handover conditions that reflect this difference may be used in certain wireless communication systems using NTNs.

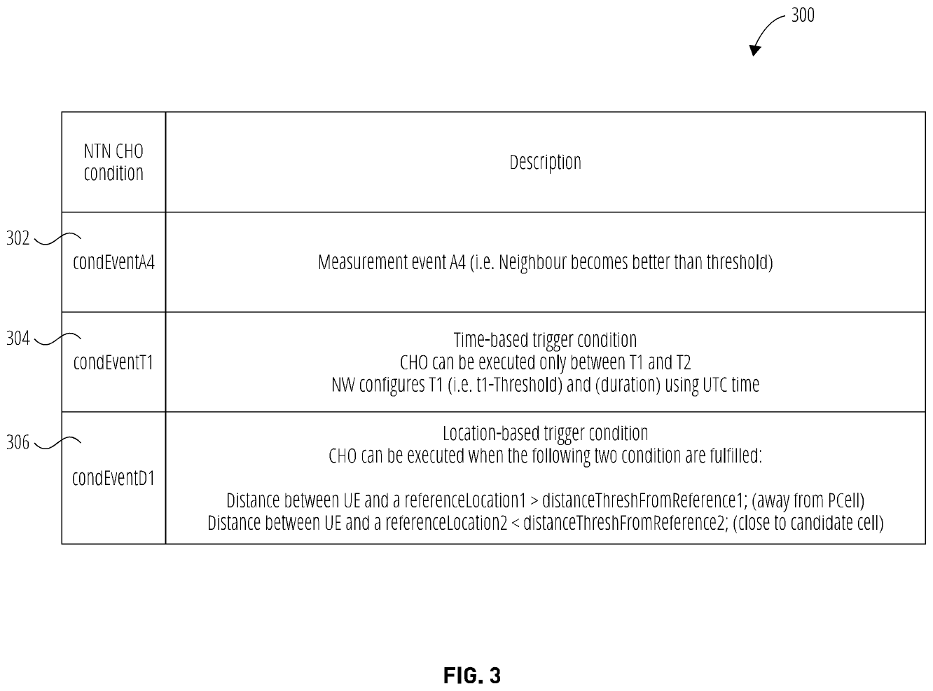

FIG. 3 illustrates a table 300 of NTN conditional handover conditions, according to embodiments herein. A first NTN conditional handover condition 302 may be a “condEventA4” condition. The first NTN conditional handover condition 302 may check for “measurement event A4,” which may be defined as the case that a quality (e.g., RSRP) of a neighbor cell of the current serving cell has become better than a quality of a current serving cell.

A second NTN conditional handover condition 304 may be a “condEventT1” condition. The second NTN conditional handover condition 304 may be a time-based trigger condition where a conditional handover may only be executed between a first time T1 and a second time T2. The network may configure the time T1 (e.g., as t1-Threshold) and a duration from T1 that corresponds to T2.

A third NTN conditional handover condition 306 may be a “condEventD1” condition. The third NTN conditional handover condition 306 may be a location-based trigger condition, where conditional handover can be executed when a distance between the UE and a first reference location is greater than a distance threshold for the first reference location and when the distance between the UE and a second reference location is less than a distance threshold for the second reference location. In such cases, the first reference location may be a location of a current serving cell and the second reference location may be a location of a candidate serving cell for the conditional handover.

In some cases, a “condEventT1” NTN conditional handover condition and a “condEventD1” NTN conditional handover condition may be configured together along with a measurement-based NTN conditional handover condition, such as the “condEventA4” or another measurement-based trigger condition (e.g., that uses A3, A4, and/or A5 measurement events for conditional handover).

When using a “condEventT1” NTN conditional handover condition with a candidate cell, it may be that conditional handover recovery, if necessary, cannot be executed if the timer T2 has not expired.

When using a “condEventD1” NTN conditional handover condition with a candidate cell, it may be that conditional handover recovery, if necessary, can be executed without first checking for “condEventD1.”

It is contemplated that a “condEventD1” NTN conditional handover condition may be configured as a normal measurement event for a measurement report.

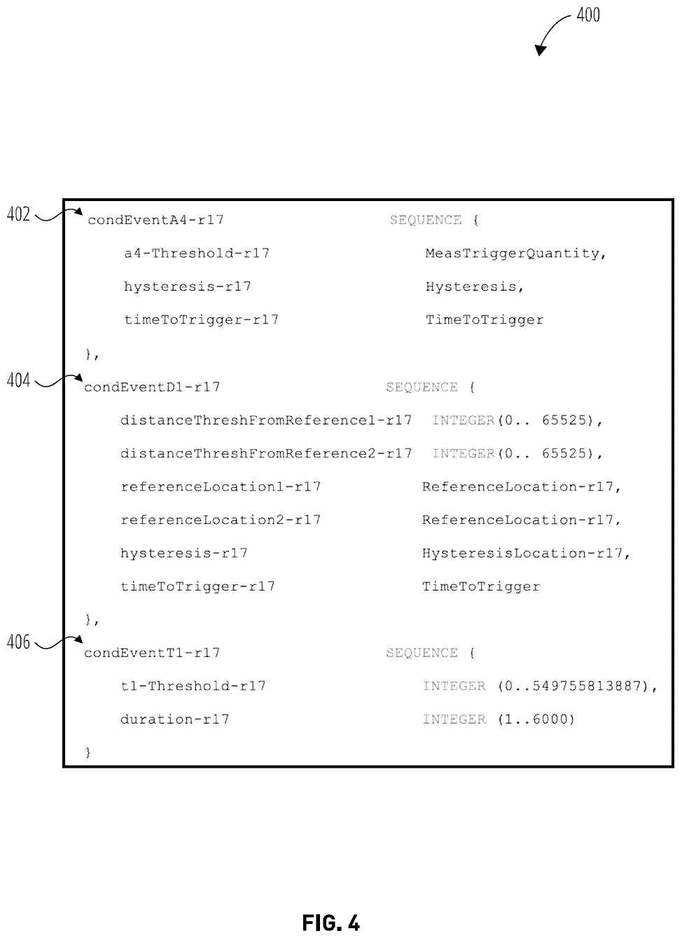

FIG. 4 illustrates various definitions 400 for NTN conditional handover conditions, according to embodiments herein. The definitions 400 may be used in, for example, wireless communication systems defined per one or more 3GPP specifications.

The definitions 400 include a first definition 402 for a “condEventA4” NTN conditional handover condition, a second definition 404 for a “condEventD1” NTN conditional handover condition, and a third definition 406 for a “condEventT1” NTN conditional handover condition.

There are various scenarios where NTN cells move relative to the surface of the earth (e.g., because the satellite on which a payload is sited is in other than GEO, for example, in an LEO). As such an NTN cell moves relative to the earth's surface, it may be that UEs in a geographic area may begin to lose coverage and thus may need to perform handover to a new cell (e.g., that is broadcast by another payload of another satellite).

In some circumstances, a satellite that moves relative to the surface of the earth will come to be operated by a new base station (e.g., that is closer to its current location than a base station previously operating the satellite). Such cases involve the establishment of a new feeder link between the satellite and the (new) base station. In cases of feeder link switching, a cell served by the payload on the satellite may change (e.g., to be a cell of the new base station). In such cases, all UEs presently served in that cell/by the payload may need to perform handover to the new cell due to the cell information change (even though there may be no change on their service links with the payload).

Considering the large size of NTN cells (relative to, e.g., cells broadcast by terrestrial-based equipment), it is possible that many devices are served by a single NTN cell. Further, depending on constellation assumptions (e.g., propagation delay and/or satellite speed) and UE density, it may be that a very large number of UEs may need to perform handover to/from the NTN cell at the same time. This may implicate a correspondingly large amount of signaling overhead relative to these handovers. Further, service continuity challenges during handover and/or cell congestion (e.g., due to group UE handover) may be a concern.

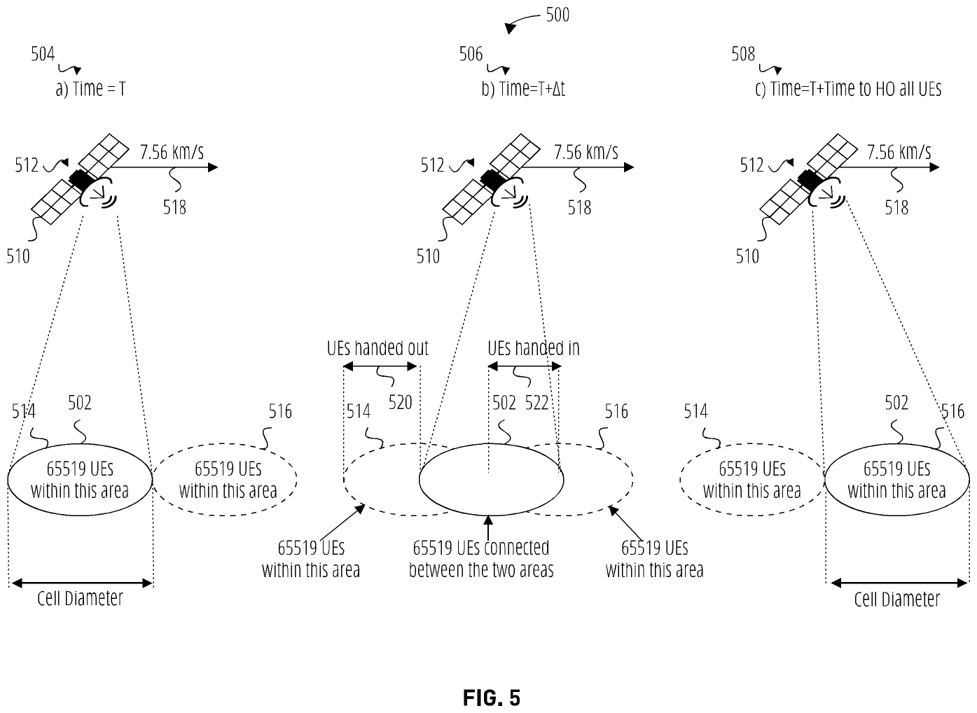

FIG. 5 illustrates a diagram 500 illustrating a handover scenario for an NTN cell 502, according to an embodiment. At a first time 504 (time T), a satellite 510 having a payload 512 broadcasting the NTN cell 502 is located such that the coverage of the NTN cell 502 is co-extensive with a first geographic area 514, as illustrated. Within the first geographic area 514, there may be a large number of UEs being served by the NTN cell 502 (the diagram 500 provides 65,519 such UEs by way of example and not by way of limitation). As illustrated, there are also a large number of UEs in a second geographic area 516 that are physically outside coverage of, and therefore not served by, the NTN cell 502 (the diagram 500 provides 65,519 such UEs by way of example and not by way of limitation).

Because the satellite 510 moves 518 relative to the surface of the earth (e.g., at 7.56 km/s as illustrated in the diagram 500, which is given by way of example and not by way of limitation), at the second time 506 (time T+Δt), the satellite 510 is positioned such that the NTN cell 502 covers part of the first geographic area 514 and part of the second geographic area 516, as illustrated. UEs from the first geographic area 514 that are located in the uncovered area 520 of the first geographic area 514 at this time have been handed out of the NTN cell 502, while UEs from the second geographic area 516 that are located in the covered area 522 at this time have been handed into the NTN cell 502. Because of the large number of UEs in each of the first geographic area 514 and the second geographic area 516, the number of such handovers may have been very large (e.g., as illustrated, a large number of UEs remain connected via the NTN cell 502 at the second time 506).

At the third time 508 (time T+a time to perform all handovers for all the UEs), the satellite 510 is positioned such that the coverage of the NTN cell 502 is co-extensive with the second geographic area 516, as illustrated. Further, the NTN cell 502 may serve the UEs present in the second geographic area 516.

Using the example numbers in the diagram 500, from the first time 504 to the third time 508, 65,519 UEs located in the first geographic area 514 were handed out of the NTN cell 502, and 65,519 UEs located in the second time 506 were handed into the NTN cell 502. This large number of handovers implicates a large amount of signaling overhead (and the potential for service continuity challenges during handover and/or cell congestion, as discussed herein). Accordingly, systems and methods for handover signaling reduction may be useful for alleviating such issues and/or for allowing for the handover of a large amount of UEs within system signaling constraints.

A first direction for reducing handover signaling involves reducing portions of handover signaling corresponding to the target serving cell configuration (where the target serving cell is the cell to which the UE is to perform handover to). It may be that part(s) of a handover configuration and/or a handover execution indication that inform of a configuration for operating with the target serving cell of the handover may be common for multiple/many UE. Accordingly, it may be possible to split a configuration for operating on the target serving cell into two parts: a common configuration (e.g., that corresponds to common configuration information for operating on the target serving cell that is the same for multiple UEs) and a dedicated configuration (that corresponds to dedicated configuration information for operating on the target serving cell that is particular to that particular UE).

FIG. 6 illustrates a flow diagram 600 for a framework for the separate treatment of common configuration information and dedicated configuration information, according to embodiments herein. A network 602 sends 608 common configuration information for operating on a target serving cell to a plurality of UEs including, but not limited to, the first UE 604 and the second UE 606 in a point-to-multipoint (PTM) transmission (e.g., a broadcast transmission). This PTM transmission may be sent by a source base station operating a source serving cell that currently serves the plurality of UEs. This common configuration information may include a common configuration for the target serving cell, and/or it may include information that allows the UE to derive a common configuration for the target serving cell.

Each of the plurality of UEs optionally sends feedback to the network 602 that indicates that the PTM transmission having the common configuration information was received at the particular UE. For example, the first UE 604 optionally sends 610 first such feedback to the network 602, and the second UE 606 optionally sends 612 second such feedback to the network 602.

The network then sends (e.g., via the source serving cell) handover commands to one or more of the plurality of UEs (e.g., all of the plurality of UEs, or those of the plurality of UEs that provided feedback). These handover commands may be dedicated transmissions, with one for each such UE. Further, each such dedicated transmission may include dedicated configuration information for that particular UE for operating on the target serving cell. The dedicated configuration information may include, for example, a dedicated configuration for the UE for the target serving cell, and/or it may include information that allows the UE to derive a dedicated configuration for the UE for the target serving cell. As illustrated, these handover commands may be conditional handover commands in some cases.

For example, as illustrated, the network 602 sends 614 (e.g., via the source serving cell) a first such dedicated transmission to the first UE 604 that contains dedicated configuration information for the first UE 604 for operating on the target serving cell. Further, the network 602 sends 616 (e.g., via the source serving cell)

In response to receiving a PTM transmission having the common configuration information for operating with the target serving cell and a dedicated transmissions having dedicated configuration information for operating with the target serving cell, a UE is then enabled to perform the handover to the target serving cell according to a common configuration corresponding to the common configuration information and a dedicated configuration corresponding to the dedicated configuration information.

In some cases, a common configuration may include a cell specific configuration. This cell specific configuration may correspond to of, for example, information found in a master information block (MIB) and/or one or more system information blocks (SIB) for the cell. This cell specific information may represent a common part of a serving cell configuration for the cell.

In some cases, a common configuration may include a group specific configuration. For example, the common configuration may be for configuring UEs within a certain geographical area within the NTN cell (e.g., that communicate on a beam of the associated NTN payload that is for that geographical area within the NTN cell). Accordingly, it is understood that in some cases, a common configuration for UEs may be for a group of UEs that does not (necessarily) include all UEs of the serving cell. Parameters that may be associated with this type of common configuration may be up to network implementation.

In some cases, a common configuration may also be understood to include any common parts of UE specific configuration(s) (e.g., parts of a nominally dedicated UE specific configuration(s) that are in any event the same for multiple/many/all UEs within a cell). Parameters that may be associated with this type of common configuration may be up to network implementation.

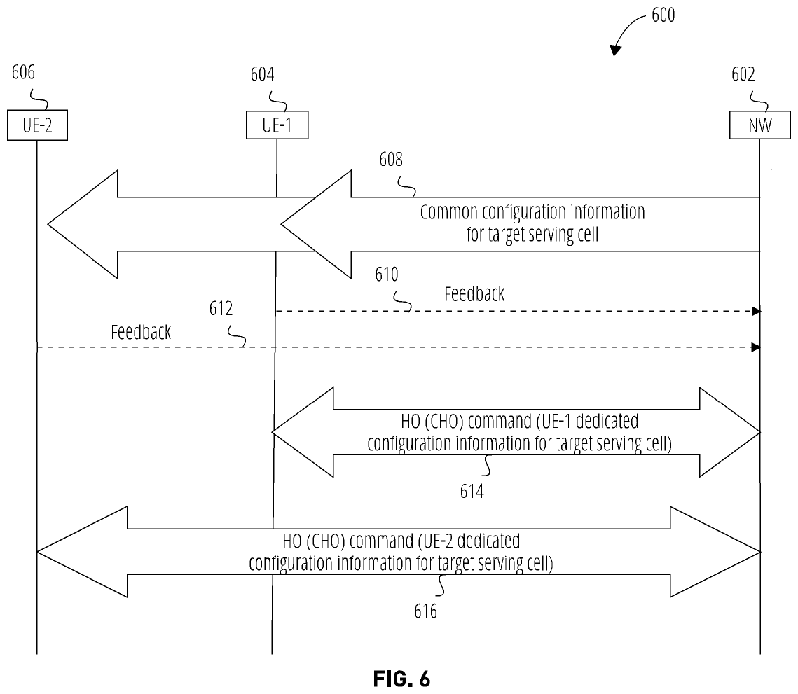

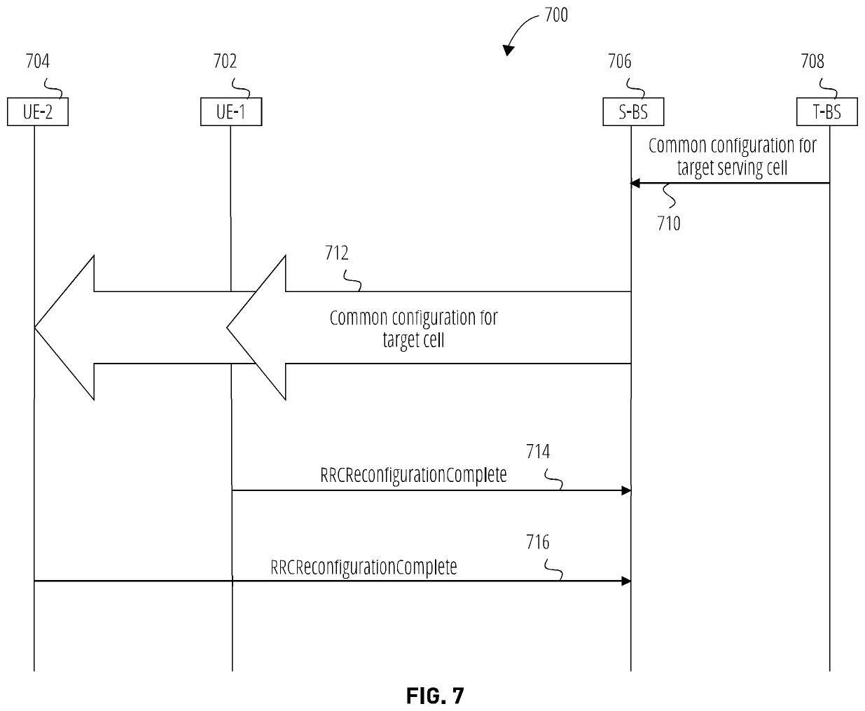

FIG. 7 illustrates a flow diagram 700 for the provision of common configuration information for operating on a target serving cell in a broadcast or PTM manner, according to an embodiment. The flow diagram 700 illustrates a mechanism of using a (full) common configuration for the target serving cell as common configuration information in a PTM transmission. The flow diagram 700 illustrates communications between/among a first UE 702, a second UE 704, a source base station (labelled “S-BS”) 706 and a target base station (labelled “T-BS”) 708.

A plurality of UEs including, but not limited to, the first UE 702 and the second UE 704 are presently served by a source serving cell on the source base station 706, and are to be handed over to a target serving cell. In some cases, it may be that the target serving cell is a cell of the target base station 708. In such cases, the target base station 708 sends 710 a common configuration for the target serving cell to the source base station 706, such that the source base station 706 is made aware of the common configuration for the target serving cell.

In other cases, it may be that the target serving cell is a cell of the source base station operating the source serving cell, in which case the source base station is already aware of the common configuration for the target serving cell.

Then, the source base station 706 sends 712 common configuration for the target serving cell to the plurality of UEs (including the first UE 702 and the second UE 704, as illustrated) in a PTM transmission. Note that the use of the PTM transmission reduces signaling relative to cases where individual transmissions having this common configuration for each of the plurality of UEs are instead sent.

The PTM transmission may be sent in a message that uses a group radio network temporary identifier (G-RNTI) that is known to each of the plurality of UEs, thereby indicating that the PTM transmission is for that plurality of UEs. In such cases, it may be understood that the plurality of UEs to which the PTM transmission is directed is a UE group corresponding to that G-RNTI. A G-RNTI for this PTM transmission may be preconfigured to a UE (e.g., by previous dedicated signaling to the UE), and/or may be derived in a known manner based on a UE's cell radio network temporary identifier (C-RNTI).

Once the UEs receive the PTM transmission, they may provide feedback to the source base station 706. For example, the first UE 702 sends 714 a first feedback message to the source base station 706, and the second UE 704 sends 716 a second feedback message to the source base station 706. In some cases, this feedback message may include a UE dedicated layer 3 (L3) RRCReconfigurationComplete message (e.g., as illustrated in the flow diagram 700). This L3 RRCReconfigurationComplete message may be used in, for example, cases where conditional handover is being used. In some cases, this feedback message may include layer 2 (L2) radio link control (RLC) acknowledgement (ACK) feedback. In some cases, this feedback message may include layer 1 (L1) hybrid automatic repeat request acknowledgement (HARQ-ACK) signaling. In some embodiments, this feedback message may include a medium access control control element (MAC CE).

The PTM transmission may include the common configuration in an RRCReconfiguration message, which may use an existing signaling radio bearer (SRB). In other cases, the common configuration may instead be included in a radio resource control (RRC) message on a newly established SRB.

In some cases, the PTM transmission having the common configuration may be transmitted in a secure way. This may not be necessary in the case that the common configuration contains/corresponds to a cell level common configuration, because such information is already broadcast by the system (e.g., in MIB/SIBs) and therefore assumed to be already available on an unsecured basis in any event. However, in cases where the common configuration information contains/corresponds to, for example, a group specific configuration or a common configuration reflecting a common part of UE specific configuration(s), it may be beneficial to use security protection.

In some cases, a group ciphering key and a group integrity protection key are configured and generated for the plurality of UEs. The PTM transmission is then encrypted at the source base station 706 for use with the group ciphering key and the group integrity protection key, and the plurality of UEs (including, e.g., the first UE 702 and the second UE 704) then uses the group ciphering key and the group integrity protection key to decrypt the PTM transmission. It will be understood based on the names that the group ciphering key is used to un-cipher the PTM transmission at a UE, while the group integrity protection key is used to verify the integrity of the PTM transmission as received.

In some cases, a dedicated integrity protection key is configured and generated for each of the plurality of UEs. Then, a message authentication code for integrity (MAC-I) for each of the plurality of UEs corresponding to data of the PTM transmission is generated at the source base station 706 and sent in the PTM transmission having the common configuration.

Upon receiving the PTM transmission, each UE may verify the integrity of the PTM transmission by applying its dedicated integrity protection key with the PTM transmission and checking for a match of the corresponding MAC-I for the UE included with the PTM transmission.

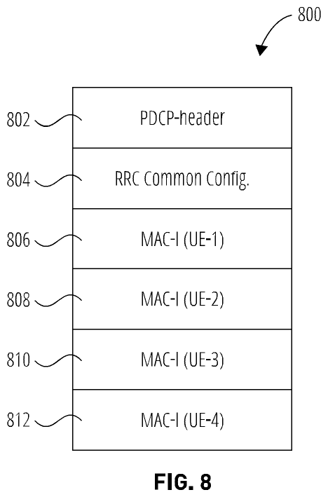

FIG. 8 illustrates a packet data convergence protocol (PDCP) protocol data unit (PDU) format 800 for a PTM transmission, according to embodiments herein. The PDCP PDU format 800 includes a PDCP header 802 and an RRC common configuration 804 (which may be an example of common configuration information as discussed herein). Further, the PDCP PDU format 800 includes a first MAC-I 806 for a first UE of a plurality of UEs that is to receive a PTM transmission, a second MAC-I 808 for a second UE of the plurality of UEs that is to receive the PTM transmission, a third MAC-I 810 for a third UE of the plurality of UEs that is to receive the PTM transmission, and a fourth MAC-I 812 for a fourth UE of the plurality of UEs that is to receive the PTM transmission.

In some cases, common configuration information sent in the PTM transmission may include difference configuration information. This difference configuration information may include portions of a common configuration for the target serving cell that are different than a common configuration for the source serving cell. The difference configuration information may not include portions of a common configuration for the target serving cell that are the same as a common configuration for the source serving cell. In this way, the amount of information that is transferred in the PTM transmission may be reduced (as compared to, e.g., a case where an entire common configuration for the target serving cell is sent in the PTM transmission).

UEs receiving the difference configuration information may then update their common configuration for the source serving cell with the difference configuration information to generate or derive a common configuration for the target serving cell.

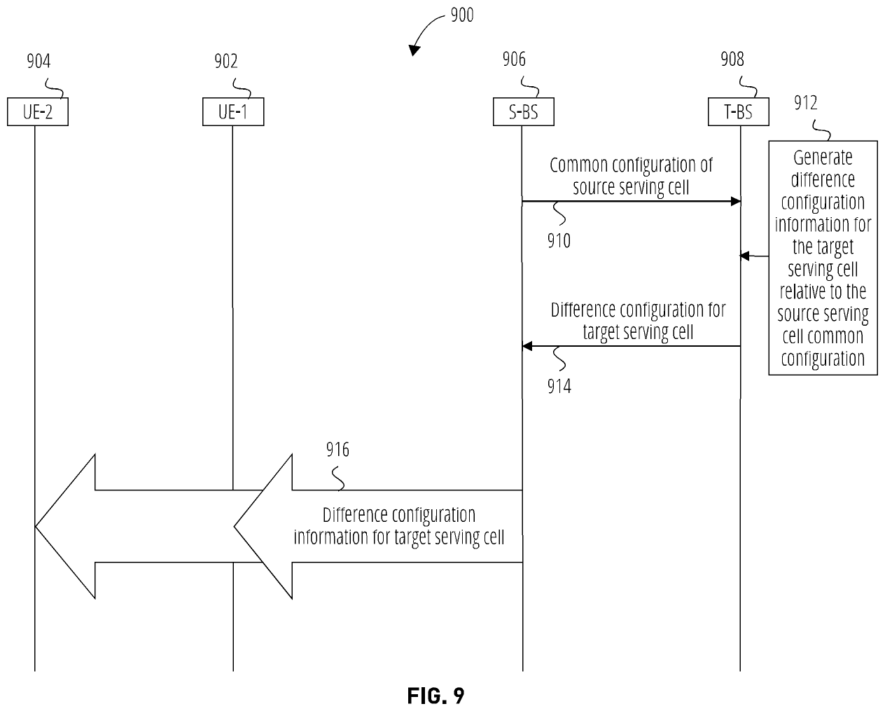

FIG. 9 illustrates a flow diagram 900 for the provision of common configuration information for operating on a target serving cell in a broadcast or PTM manner, according to an embodiment. The flow diagram 900 illustrates a first option for generating and using difference configuration information as common configuration information in a PTM transmission. The flow diagram 900 illustrates communications between/among a first UE 902, a second UE 904, a source base station (labelled “S-BS”) 906 and a target base station (labelled “T-BS”) 908.

In some cases, it may be that the target serving cell is a cell of the target base station 908. In such cases, the source base station 906 sends 910 a common configuration for the source serving cell to the target base station 908 so that the target base station 908 aware of the source serving cell common configuration. The target base station 908 then generates 912 difference configuration information for the target serving cell relative to the common configuration of the source serving cell. The target base station 908 then sends 914 this difference configuration information to the source base station 906.

In other cases, it may be that the target serving cell is a cell of the source base station operating the source serving cell, in which case the source base station is already aware of the common configuration for the target serving cell. In such cases, the source base station may itself generate the difference configuration information for the target serving cell relative to the common configuration for the source serving cell.

The source base station 906 then sends 916 a PTM transmission including the difference configuration information to a plurality of UEs (e.g., including the first UE 902 and the source base station 906, as illustrated). These UEs may then update their common configuration for the source serving cell with the difference configuration information to generate or derive a common configuration for the target serving cell.

It is contemplated that behaviors discussed in relation to the PTM transmission of the flow diagram 700 (which included a (full) common configuration for the target serving cell as common configuration information rather a difference configuration information as common configuration information) could be analogously used in the case of the PTM transmission of the flow diagram 900. For example, the PTM transmission of the flow diagram 900 may analogously make use of G-RNTI, UE feedback messages, RRC messaging, ciphering, and/or integrity protection mechanisms as these were described in relation to the PTM transmission of the flow diagram 700.

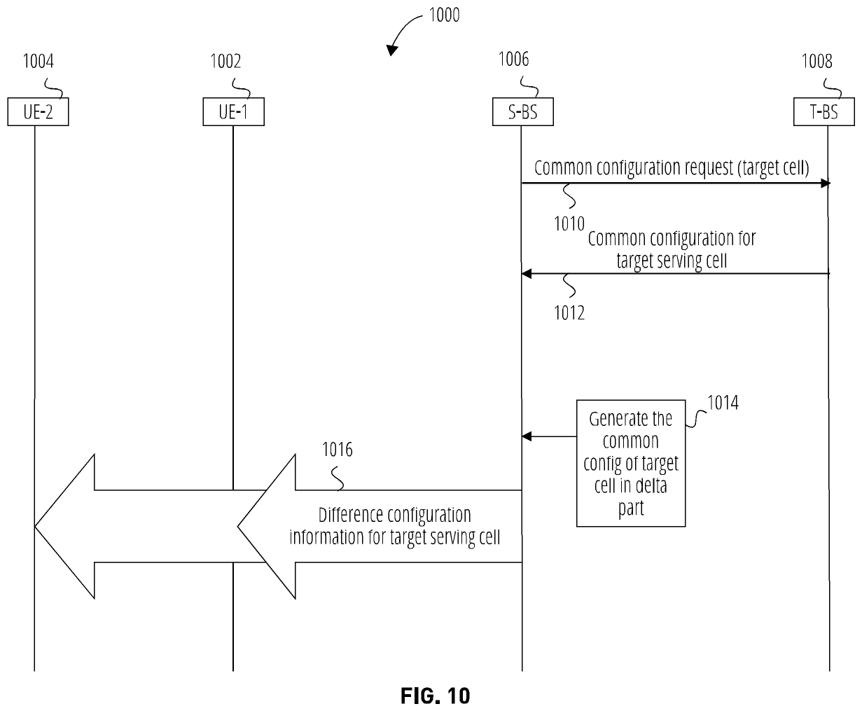

FIG. 10 illustrates a flow diagram 1000 for the provision of common configuration information for operating on a target serving cell in a broadcast or PTM manner, according to an embodiment. The flow diagram 1000 illustrates a second option for generating and using difference configuration information as common configuration information in a PTM transmission. The flow diagram 1000 illustrates communications between/among a first UE 1002, a second UE 1004, a source base station (labelled “S-BS”) 1006 and a target base station (labelled “T-BS”) 1008.

In some cases, it may be that the target serving cell is a cell of the target base station 1008. In such cases, the source base station 1006 sends 1010 a request for a common configuration for the source serving cell to the target base station 1008. In response, the target base station 1008 sends 1012 a common configuration for the target serving cell to the source base station 1006 so that the source base station 1006 is aware of the target serving cell common configuration.

In other cases, it may be that the target serving cell is a cell of the source base station operating the source serving cell, in which case the source base station is already aware of the common configuration for the target serving cell, and thus this signaling is not used.

Then, using the common configurations for each of the source serving cell and the target serving cell, the source base station 1006 generates 1014 difference configuration information for the target serving cell relative to the common configuration for the source serving cell.

The source base station 1006 then sends 1016 a PTM transmission including the difference configuration information to a plurality of UEs (e.g., including the first UE 1002 and the second UE 1004, as illustrated). These UEs may then update their common configuration for the source serving cell with the difference configuration information to generate or derive a common configuration for the target serving cell.

It is contemplated that behaviors discussed in relation to the PTM transmission of the flow diagram 700 (which included a (full) common configuration for the target serving cell as common configuration information rather a difference configuration information as common configuration information) could be analogously used in the case of the PTM transmission of the flow diagram 1000. For example, the PTM transmission of the flow diagram 1000 may analogously make use of G-RNTI, UE feedback messages, RRC messaging, ciphering, and/or integrity protection mechanisms as these were described in relation to the PTM transmission of the flow diagram 700.

In some cases, a UE may acquire common configuration information for a target serving cell without the use of a PTM transmission from a base station having the common configuration, as is described herein in some embodiments. It may be, for example, that a common configuration for a target serving cell that is a cell specific configuration may correspond to information broadcast by the target serving cell, such as information found in a MIB and/or one or more SIBs broadcast by that serving cell. In such cases, it is possible for the UE to acquire a common configuration for the target serving cell from the MIB and/or the one or more SIBs.

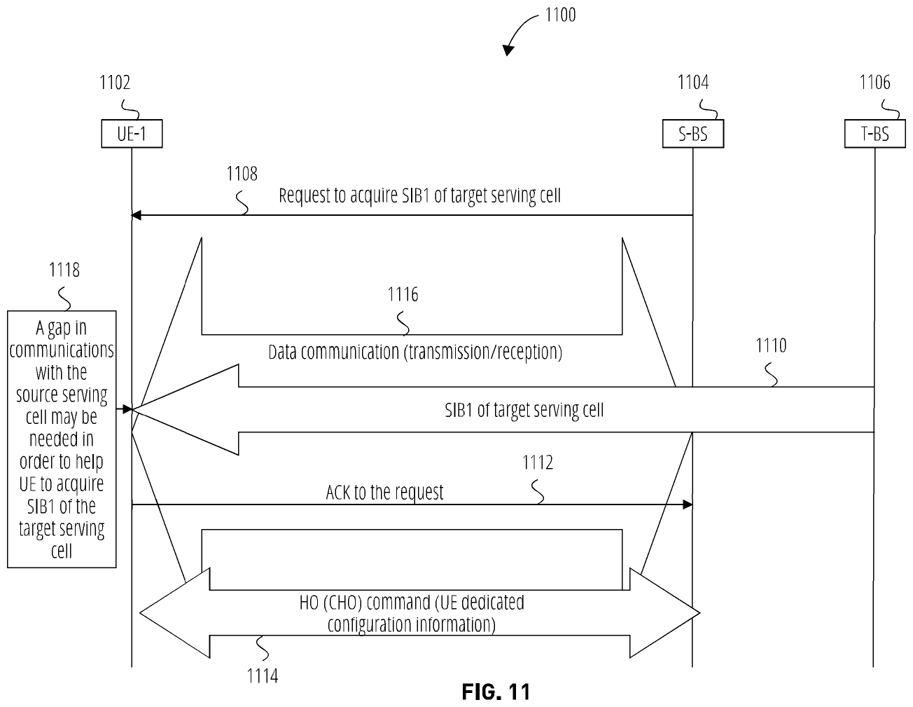

FIG. 11 illustrates a flow diagram 1100 for UE acquisition of common configuration information, according to an embodiment. The flow diagram 1100 illustrates a first option for implementing handover based on a UE acquisition of a common configuration for the target serving cell from broadcast signaling (e.g., one or more SIBs) of the target serving cell. The flow diagram 1100 illustrates communications between/among a UE 1102, a source base station (labelled “S-BS”) 1104 and a target base station (labelled “T-BS”) 1106.

A source base station may first send, to a UE, a request that the UE acquire one or more SIBs of the target serving cell that have common configuration information that may be used by the UE on the target serving cell. As illustrated in the flow diagram 1100, the source base station 1104 sends 1108 a request to the UE 1102 that the UE 1102 acquire SIB1 of the target serving cell.

The flow diagram 1100 corresponds to a case where SIB1 includes (be itself) sufficient common configuration information for the UE to determine a common configuration for operation on the target serving cell. This use of SIB1 is given by way of example and not by way of limitation. It is contemplated that in other unillustrated embodiments, multiple SIBs may be acquired in order provide the UE with appropriate common configuration information. It is also contemplated that SIB(s) other than SIB1 may be provided to the UE in some cases for purposes of providing appropriate common configuration information (e.g., a case where the target serving cell is an NTN cell, in which case the acquisition of SIB19 may be appropriate within some wireless communication systems).

The request from the source base station to the UE may identify the one or more SIBs that are to be acquired by the UE. For example, in the flow diagram 1100, the illustrated request identifies SIB1 of the target serving cell to the UE 1102.

The request from the source base station to the UE may be carried in an SIB of the source serving cell. Alternatively, the request may be carried in paging between the source base station 1104 and the UE. Alternatively, the request may be carried in an RRC message between the source base station 1104 and the UE. Alternatively, the request may be carried in one of an L2 message and an L1 message between the source base station 1104 and the UE.

In response to the request as described, the UE may acquire the appropriate SIB(s) of the target serving cell (e.g., prior to performing initial access on the target serving cell). In the flow diagram 1100, the UE 1102 acquires 1110 the SIB1 of the target serving cell, per the previously received request.

Once the SIB(s) having the common configuration information have been received, the UE sends an acknowledgement (ACK) to the source base station. For example, in the flow diagram 1100, once the UE 1102 receives the SIB1, it sends 1112 the illustrated ACK to the source base station 1104. Such an ACK may be sent in any of L3, L2, or L1 signaling.

Once the ACK is received at the source base station, the source base station may send a handover command to the UE 1102 to perform handover to the target serving cell. For example, in the flow diagram 1100, once the illustrated ACK is received at the source base station 1104, the source base station 1104 sends 1114 a handover command to the UE 1102. This handover command may include dedicated configuration information for operating the UE on the target serving cell.

It is anticipated that in some cases (as illustrated in the flow diagram 1100) that this handover command may be a conditional handover command.

In response to the handover command, the UE may perform a handover from the source serving cell to the target serving cell. This handover may be based on the common configuration information (received in the SIB(s)) and the dedicated configuration information (received in the handover command), with the result that the UE operates on the target serving cell according to a common configuration corresponding to the common configuration information and a dedicated configuration corresponding to the dedicated configuration information.

It is noted that during the period between the request and the handover, the UE may remain in communication with the source base station 1104. For example, in the flow diagram 1100, the UE 1102 continues to perform communications 1116 with the source base station 1104. However, as noted 1118, a gap in the communications 1116 with the source serving cell may be used at the time(s) that the UE 1102 acquires the SIB(s) of the target serving cell (to allow for the acquisition of the SIB(s)).

It is further noted that while the flow diagram 1100 illustrates a case where the source serving cell is operated by a source base station 1104 and the target serving cell is operated a (separate) target base station 1106, this is given by way of example and not by way of limitation. It may be that the target serving cell is also a cell operated by the source base station operating the source serving cell, in which case, the UE would perform acquisition of the SIB(s) from the target serving cell as broadcast from that (same) base station.

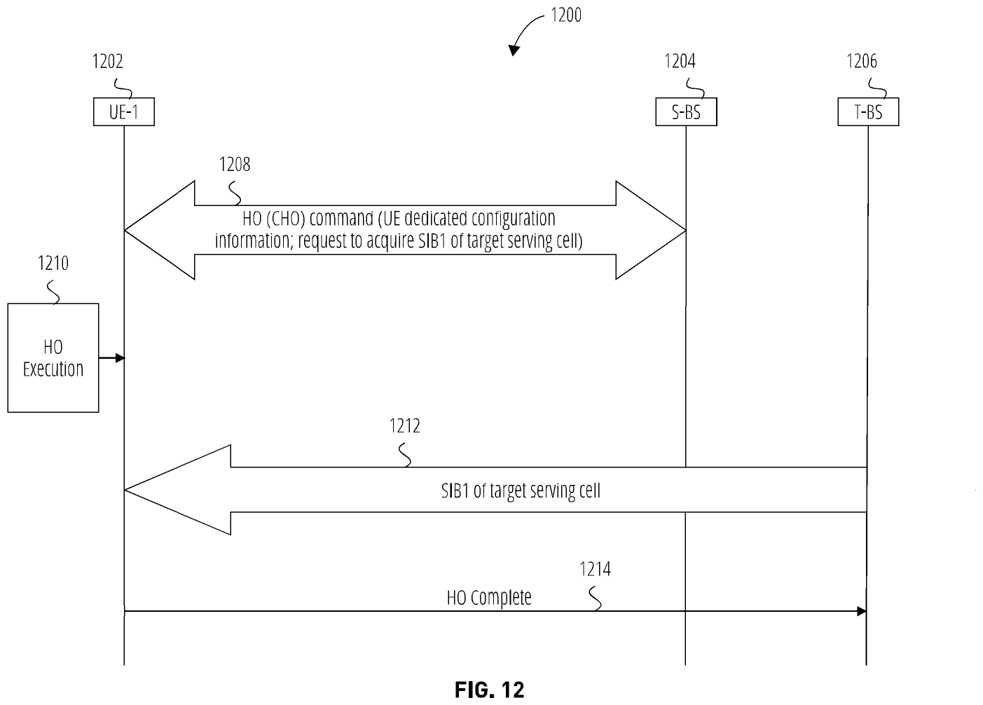

FIG. 12 illustrates a flow diagram 1200 for UE acquisition of common configuration information, according to an embodiment. The flow diagram 1200 illustrates a second option for implementing handover based on a UE acquisition of a common configuration for the target serving cell from broadcast signaling (one or more SIBs) of the target serving cell. The flow diagram 1200 illustrates communications between/among a UE 1202, a source base station (labelled “S-BS”) 1204 and a target base station (labelled “T-BS”) 1206.

The source base station sends 1208 handover command to the UE 1202 to perform handover to the target serving cell. The handover command may contain a request that the UE acquire one or more SIBs of the target serving cell that have common configuration information that may be used by the UE on the target serving cell. As one example, the handover request illustrated in the flow diagram includes a request for the UE 1202 to acquire SIB1 of the target serving cell.

The flow diagram 1200 corresponds to a case where SIB1 includes (itself) sufficient common configuration information for the UE to determine a common configuration for operation on the target serving cell. This use of SIB1 is given by way of example and not by way of limitation. It is contemplated that in other unillustrated embodiments, multiple SIBs may be acquired in order provide the UE with appropriate common configuration information. It is also contemplated that SIB(s) other than SIB1 may be provided to the UE in some cases for purposes of providing appropriate common configuration (e.g., a case where the target serving cell is an NTN cell, in which case the acquisition of SIB19 may be appropriate within some wireless communication systems).

The request portion of the handover command from the source base station to the UE may identify the one or more SIBs that are to be acquired by the UE. For example, in the flow diagram 1200, the request portion of the illustrated handover command identifies SIB1 of the target serving cell to the UE 1202.

This handover command may also include dedicated configuration information for operating the UE on the target serving cell.

It is anticipated that in some cases (as illustrated in the flow diagram 1100) that this handover command may be a conditional handover command.

In response to the handover command, the UE executes (e.g., executes 1210) a handover from the source serving cell to the target serving cell. As part of this handover, the UE may acquire the SIB(s) indicated in the request portion of the handover command. For example, in the flow diagram 1200, the UE 1202 acquires 1212 SIB1 of the target serving cell per the request in the illustrated handover command.

The handover is performed based on the common configuration information (received in the SIB(s)) and the dedicated configuration information (received in the handover command), with the result that the UE operates on the target serving cell according to a common configuration corresponding to the common configuration information and a dedicated configuration corresponding to the dedicated configuration information.

Once the handover is complete, the UE sends 1214 a handover complete message to the target base station that indicates that the handover to the target base station is complete. For example, in the flow diagram 1200, once the UE 1202 completes handover to the target base station 1206, it sends 1214 the illustrated handover complete message to the target base station 1206.

It is further noted that while the flow diagram 1200 illustrates a case where the source serving cell is operated by a source base station 1204 and the target serving cell is operated a (separate) target base station 1206, this is given by way of example and not by way of limitation. It may be that the target serving cell is also a cell operated by the source base station operating the source serving cell, in which case, the UE would perform acquisition of the SIB(s) from the target serving cell as broadcast from that (same) base station.

In some cases using UE acquisition of SIB(s) of the target serving cell prior to handover (e.g., as in the flow diagram 1100 and/or the flow diagram 1200), it may be that not all UE that are operable within a wireless communication system have the capability of acquiring one or more SIB(s) prior to a handover, in the manner that has been described in relation to the flow diagram 1100 and the flow diagram 1200. It is contemplated that in some such systems, a UE may be capable of sending, to a source base station, a UE capability message indicating that the UE is capable of acquiring SIB(s) of a target serving cell prior to a handover (e.g., prior to and/or as a prerequisite for the source base station sending a request to the UE to perform such an acquisition). Such a capability message may indicate/distinguish whether the UE has this capability in one or more particular cases applicable to the source serving cell and the target serving cell, such as in an inter-frequency case, in an intra-frequency case, in an FR1/FR2 differentiated case, in a TDD/FDD differentiated case, in a band level case, etc.

In some cases, it may be that a common configuration for the target serving cell is the same as (or is similar to) a current common configuration for the source serving cell of a UE that is presently being used by the UE. For example, it may be that the common configuration for the source serving cell is consistent/compatible with analogous information as found in one or more SIB(s) of the target serving cell, and/or that the common configuration for the source serving cell and the target serving cell is the same at least as they pertain to initial access by the UE. In such cases, the network may indicate to the UE to re-use the common configuration for the source serving cell for the target serving cell as well (e.g., via an indication that there is no change between the common configuration for the source serving cell and the common configuration for the target serving cell).

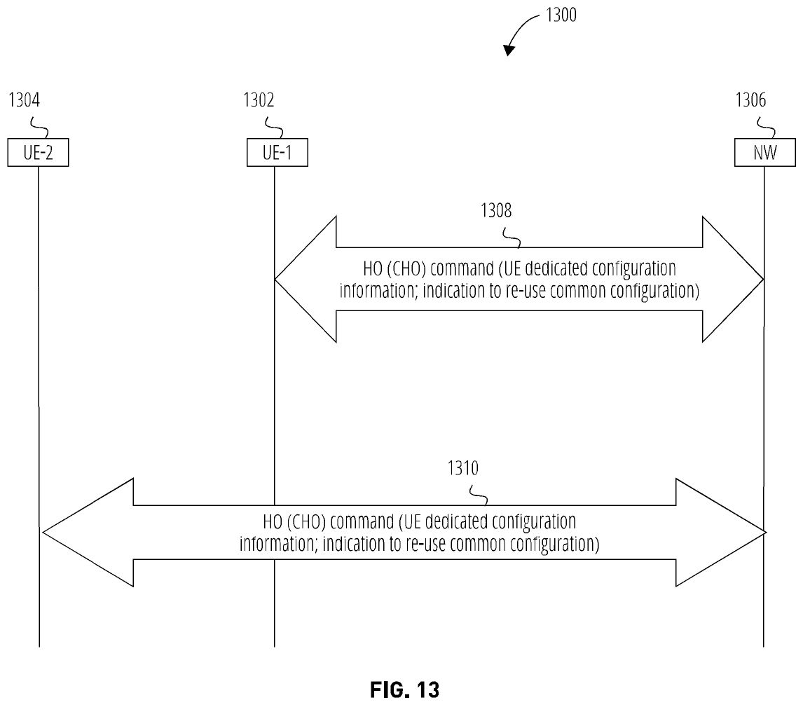

FIG. 13 illustrates a flow diagram 1300 a first case for re-use of a common configuration for a source serving cell for a handover to a target serving cell, according to an embodiment. The flow diagram 1300 illustrates communications between/among a first UE 1302, a second UE 1304, and a network 1306.

As illustrated, a network 1306 may send 1308 a handover command to a first UE 1302 that contains an indication that the common configuration for the source serving cell is to be re-used with the target serving cell (e.g., an indication that there is no change to the common configuration between the source serving cell and the target serving cell).

This handover command may also include dedicated configuration information for operating the UE on the target serving cell.

The first UE 1302 may then perform handover based on (a re-use of) the common configuration for the source serving cell of the first UE 1302 and the dedicated configuration information (received in the handover command to the first UE 1302), with the result that the first UE 1302 operates on the target serving cell according to the re-used common configuration and a dedicated configuration corresponding to its received dedicated configuration information.

Further, as illustrated, analogous actions may be performed between the network 1306 and a second UE 1304. In such a case, the network 1306 send 1310 a handover command to the second UE 1304 instructing the second UE 1304 to re-use the common configuration for the source serving cell of the second UE 1304 (which may be different than the common configuration for the source serving cell of the first UE 1302) along with dedicated configuration information provided in the handover command to the second UE 1304 (which may be different than dedicated information that was provided to the first UE 1302), with the result that the second UE 1304 operates on the target serving cell according to the re-used common configuration and a dedicated configuration corresponding to its received dedicated configuration information.

In cases where the common configuration for the target serving cell is similar to, but not exactly the same as, a current common configuration for the source serving cell of a UE that is presently being used by the UE, the network may indicate that the common configuration is to be re-used, along with one or more updated parameters for the common configuration.

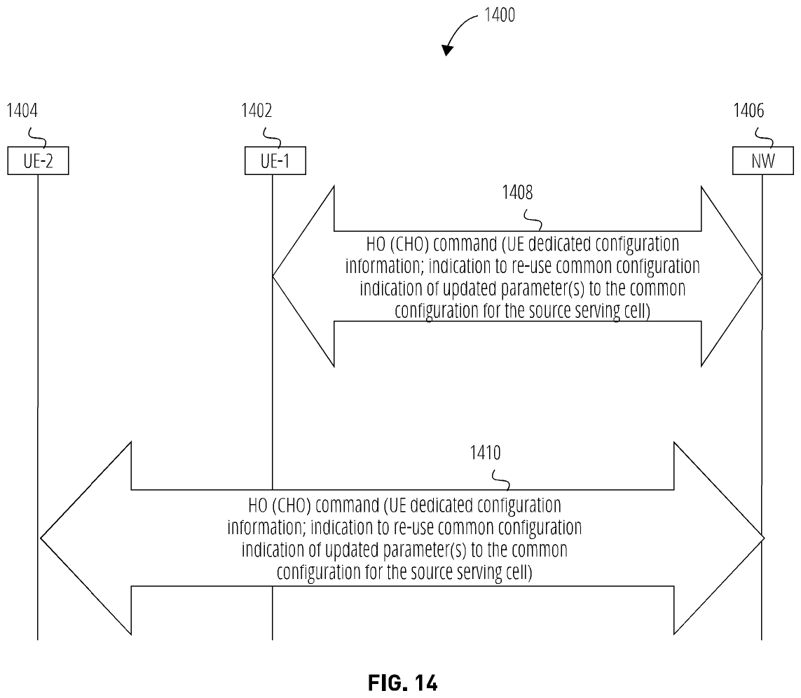

FIG. 14 illustrates a flow diagram 1400 a second case for re-use of a common configuration for a source serving cell for a handover to a target serving cell, according to an embodiment. The flow diagram 1400 illustrates communications between/among a first UE 1402, a second UE 1404, and a network 1306.

Analogously as was discussed in relation to the flow diagram 1300 of FIG. 13, the network 1406 sends 1408 a handover command to the first UE 1402 having a dedicated configuration for operating the UE on the target serving cell, along with an indication that to re-use the common configuration for the source serving cell of the UE. Additionally, this handover command further includes an indication of one or more updated parameter(s) for the common configuration that is to be re-used. The UE may then proceed to re-use the common configuration for the source serving cell for the handover to the target serving cell in conjunction with any updated parameters.

As may be seen, analogous indications may be made in the handover command between the network 1406 and the second UE 1404 in the case that the network 1406 sends 1410 a handover command to the second UE 1404. The updated parameters for the second UE 1404 may be different and/or use different values than those for the first UE 1402.

An updated parameter for a common configuration may include, for example, an updated physical cell identity (PCI), etc.

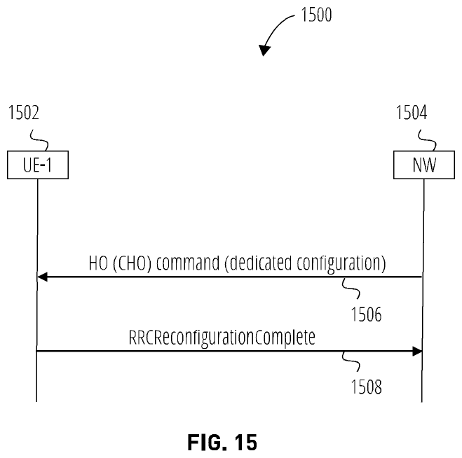

Mechanisms for the delivery of dedicated configuration information are now discussed. FIG. 15 illustrates a flow diagram 1500 for a first option for providing dedicated configuration information to a UE. A network 1504 sends 1506, to a UE 1502, a handover command that includes a dedicated configuration for a target serving cell to the UE that may be used by the UE to perform handover to the target serving cell. This handover command may be sent to the UE on a dedicated transmission. Once the UE 1502 applies the dedicated configuration, it sends 1508 an RRCReconfigurationComplete message to the network 1504.

In some cases, types of dedicated configuration information other than a dedicated configuration may be sent as described an handover command as illustrated in the flow diagram 1500. For example, it is contemplated that an index to a dedicated configuration may be sent to the UE instead, enabling the UE to then identify a dedicated configuration to use based on the index. In such cases, the handover command may be any of a L1, L2, or L3 indication in various embodiments.

It is contemplated that the handover command of FIG. 15 may in some embodiments be a conditional handover command for a conditional handover.

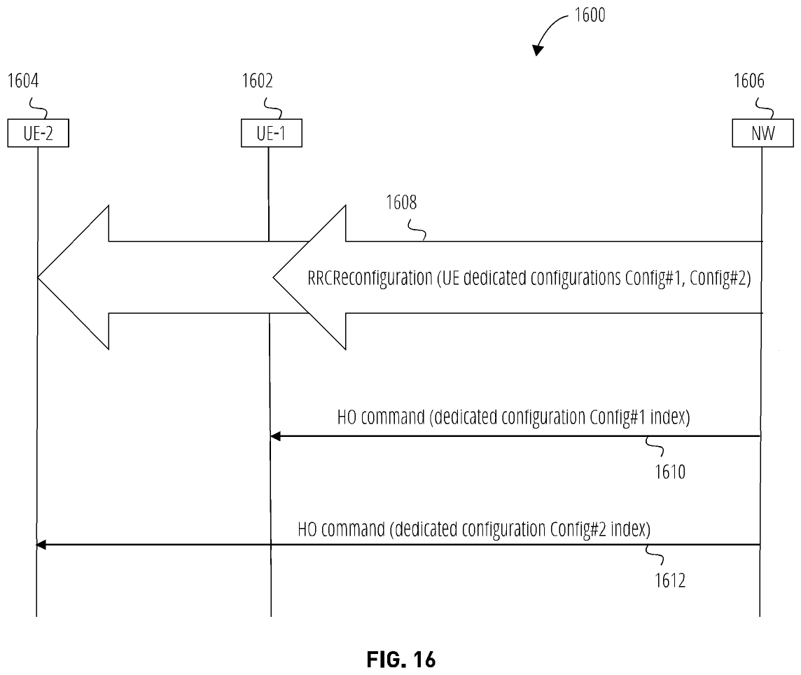

FIG. 16 illustrates a flow diagram 1600 for a second option for providing dedicated configuration information to a UE. A network may transmit a set of candidate dedicated configurations (e.g., for a corresponding set of target serving cells) in a broadcast and/or PTM manner, such that the candidate dedicated configurations may be received by a plurality of UEs served by the network. For example, in the flow diagram 1600, the network 1606 sends 1608 a PTM transmission that includes a set of candidate dedicated configurations that includes a first dedicated configuration (“Config #1”) and a second dedicated configuration (“Config #2”), which is received at each of the first UE 1602 and the second UE 1604. As illustrated, the PTM transmission may include an RRCReconfiguration message having this information.

In some embodiments, this set of candidate dedicated configurations may be included in, for example, a PTM transmission that is also used to communicate common configuration information to the plurality of UEs, as is discussed herein. In other embodiments, a new/different PTM/broadcast transmission is instead used.

Then the network may indicate, in a dedicated handover command for a UE, the candidate dedicated configuration that the UE is to use (e.g., rather than including the substantive data of a dedicated configuration in the handover command) using an index. For example, in the flow diagram 1600, the network 1606 sends 1610 a first handover command to the first UE 1602 having an index that indicates to the first UE 1602 that it is to use the first dedicated configuration, and further sends 1612 a second handover command to the second UE 1604 having an index that indicates to the second UE 1604 that it is to use the second dedicated configuration.

In such cases according to the flow diagram 1600 where the a handover command uses an index, the handover command may be any of a L1, L2, or L3 indication in various embodiments.

It is contemplated that the handover command of FIG. 16 may in some embodiments be a conditional handover command for a conditional handover.

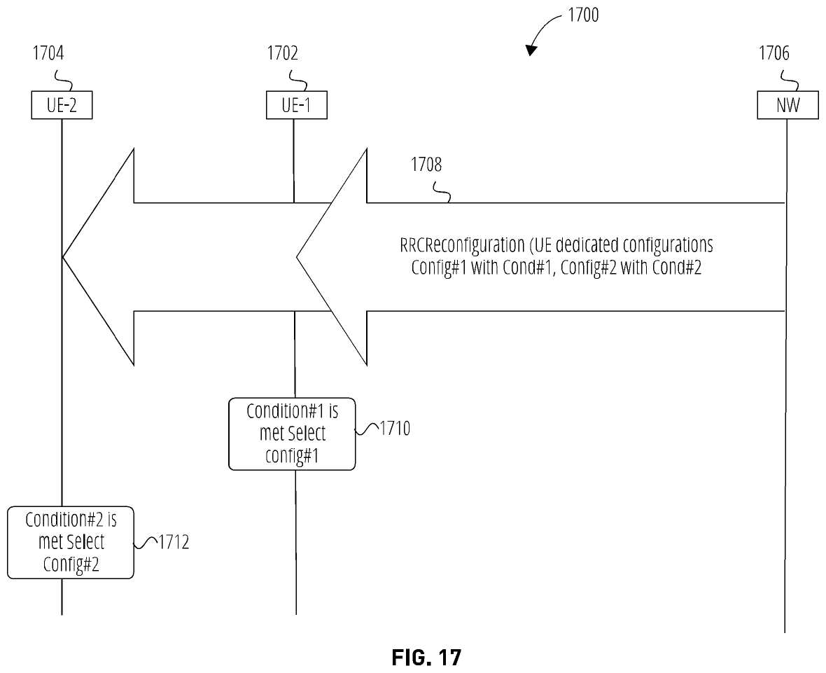

FIG. 17 illustrates a flow diagram 1700 for a third option for providing dedicated configuration information to a UE. A network may transmit a set of candidate dedicated configurations (e.g., for a corresponding set of target serving cells) in a broadcast and/or PTM manner, such that the dedicated configurations may be received by a plurality of UEs served by the network. This transmission may further include one or more condition(s) for each of the dedicated configurations that may be used by the UE to determine whether to perform handover based on the associated configuration. For example, in the flow diagram 1700, the network 1706 sends 1708 a PTM transmission that includes a set of candidate dedicated configurations that includes a first dedicated configuration (“Config #1”) and first one or more condition(s) (“Cond #1”) associated with the first dedicated configuration and a second dedicated configuration (“Config #2”) and second one or more condition(s) (“Cond #2”) associated with the second dedicated configuration, which is received at each of the first UE 1702 and the second UE 1704. As illustrated, the PTM transmission may include an RRCReconfiguration message having this information.

Examples of the conditions used may be, for example, a “condEventA4” NTN handover condition, a “condEventD1” NTN handover condition, and/or a “condEventT1” NTN handover condition, as these are discussed herein.

In some embodiments, this set of candidate dedicated configurations and any associated conditions may be included in, for example, a PTM transmission that is also used to communicate common configuration information to the plurality of UEs, as is discussed herein. In other embodiments, a new/different PTM/broadcast transmission is instead used.

Then, each UE may identify a dedicated configuration that it should use for handover based on the associated conditions. For example, the first UE 1702 may identify 1710 that the first one or more condition(s) for the first dedicated configuration is/are met, and accordingly determine to perform handover based on the first dedicated configuration. Similarly, the second UE 1704 may identify 1712 that the second one or more condition(s) for the second dedicated configuration is/are met, and accordingly determine to perform handover based on the second dedicated configuration.

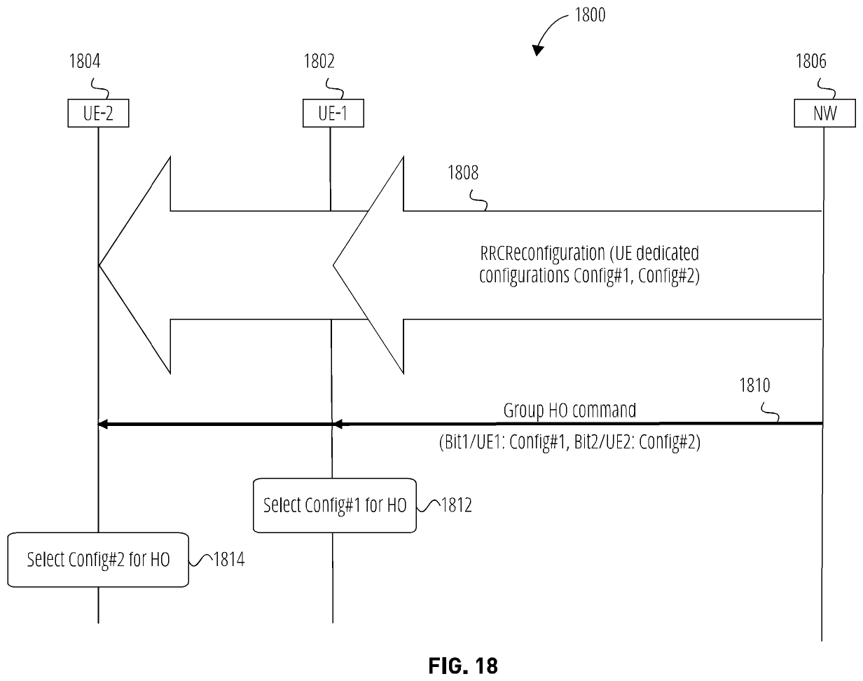

It is also contemplated that in some cases, a handover command may be a group handover command that is directed to multiple UE in a broadcast or PTM manner. FIG. 18 illustrates the use of a group handover command attendant to performing handover of a group of UEs. A network may transmit a set of candidate dedicated configurations (e.g., for a corresponding set of target serving cells) in a broadcast and/or PTM manner, such that the candidate dedicated configurations may be received by a plurality of UEs served by the network. For example, in the flow diagram 1800, the network 1806 sends 1808 a PTM transmission that includes a set of candidate dedicated configurations that includes a first dedicated configuration (“Config #1”) and a second dedicated configuration (“Config #2”), which is received at each of the first UE 1802 and the second UE 1804. As illustrated, the PTM transmission may include an RRCReconfiguration message having this information.

In some embodiments, this set of candidate dedicated configurations may be included in, for example, a PTM transmission that is also used to communicate common configuration information to the plurality of UEs, as is discussed herein. In other embodiments, a new/different PTM/broadcast transmission is instead used.

Then the network may then use a group handover command sent in a broadcast or PTM manner to cause the plurality of UEs to each perform handover. Dedicated configuration information in the group handover command may include a value for each of the UEs that indicates the one of the plurality of candidate dedicated configurations that is to be used by that UE for its HO. For example, in the flow diagram 1800, the network 1806 sends 1810 a group handover command in a broadcast or PTM manner such that it is received by each of the first UE 1802 and the second UE 1804. The group handover command includes dedicated configuration information for each of (at least) the first UE 1802 and the second UE 1804. The dedicated configuration information for the first UE 1802 arrives as a value of a first bit in the group handover command. As illustrated, that value indicates for the use of the first dedicated configuration. The dedicated configuration information for the second UE 1804 arrives as a value of a second bit in the group handover command. As illustrated, that value indicates for the use of the second dedicated configuration.

A UE then selects, based on the value received in the dedicated configuration information corresponding to that UE from the group handover command, a dedicated configuration from the candidate dedicated configurations to use to perform handover. For example, in the flow diagram 1800, the first UE 1802 selects 1812 the first dedicated configuration for handover based on the value of its corresponding bit in the group handover command. Further, the second UE 1804 selects 1814 the second dedicated configuration for handover based on the value of its corresponding bit in the group handover command.

The use of a single bit to deliver a value that indicates a particular candidate dedicated configuration for a particular UE to use (as illustrated in the flow diagram 1800) is given by way of example and not by way of limitation. It is contemplated that in some cases (e.g., when there are more than two candidate dedicated configurations), values used to indicate particular candidate dedicated configurations for particular UEs in the group handover command may be represented using multiple bits.

The order of representation for dedicated configuration information for respective UEs in the group handover command may be preconfigured or predefined. It is also contemplated that a group handover command may be sent in any of L1, L2, or L3 signaling between the network and the plurality of UEs.

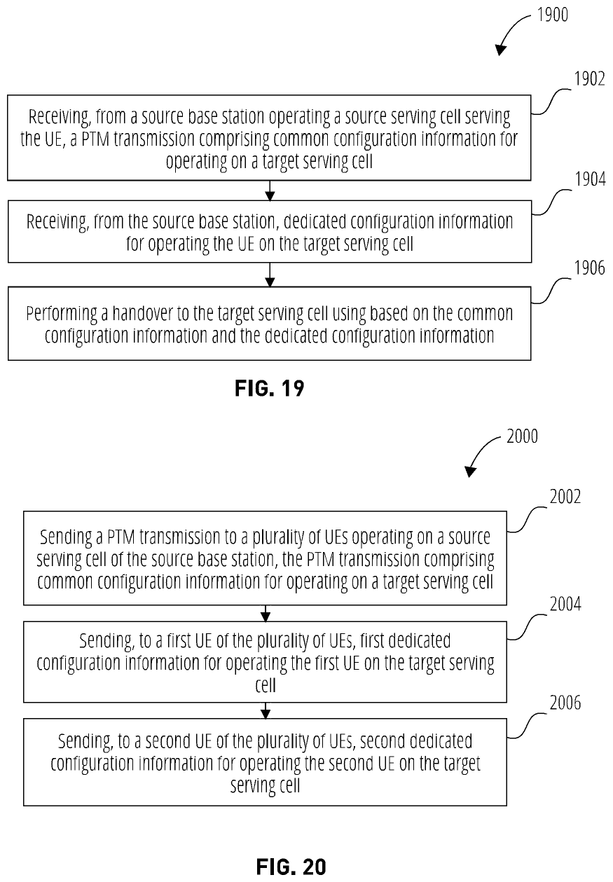

FIG. 19 illustrates a method 1900 of a UE, according to embodiments herein. The method 1900 includes receiving 1902, from a source base station operating a source serving cell serving the UE, a PTM transmission comprising common configuration information for operating on a target serving cell.

The method 1900 further includes receiving 1904, from the source base station, dedicated configuration information for operating the UE on the target serving cell.

The method 1900 further includes performing 1906 a handover to the target serving cell using based on the common configuration information and the dedicated configuration information.

In some embodiments of the method 1900, the target serving cell is a cell of a target base station.

In some embodiments, the method 1900 further includes sending feedback signaling to the source base station in response to receiving the common configuration information. In some such embodiments, the feedback signaling comprises an L3 RRCReconfigurationComplete message. In some such embodiments, the feedback signaling comprises L2 RLC ACK feedback. In some such embodiments, the feedback signaling comprises L1 HARQ-ACK signaling. In some such embodiments, the feedback signaling comprises a MAC CE.

In some embodiments of the method 1900, the PTM transmission comprises an RRCReconfiguration message having the common configuration information that is received on an existing SRB.

In some embodiments of the method 1900, the PTM transmission comprises an RRC message having the common configuration information that is received on a newly established SRB.

In some embodiments of the method 1900, the PTM transmission uses a G-RNTI of the UE that corresponds to a UE group that comprises the UE.

In some embodiments, the method 1900 further includes decrypting the PTM transmission with a group ciphering key and a group integrity protection key.

In some embodiments, the method 1900 further includes verifying an integrity of the PTM transmission by using a dedicated integrity protection key with the PTM transmission to match a MAC-I for the UE included in the PTM transmission.

In some embodiments of the method 1900, the common configuration information comprises difference configuration information relative to a common configuration for the source serving cell.

In some embodiments of the method 1900, the dedicated configuration information comprises a dedicated configuration for the UE.

In some embodiments of the method 1900, the PTM transmission further includes a plurality of candidate dedicated configurations, and wherein the dedicated configuration information comprises an index corresponding to one of the candidate dedicated configurations for the UE.

In some embodiments of the method 1900, the dedicated configuration information is sent in a dedicated handover command. In some of these embodiments, the dedicated handover command comprises a conditional handover command.

In some embodiments of the method 1900, the PTM transmission further includes a plurality of candidate dedicated configurations, the dedicated configuration information is sent in a group handover command, and the dedicated configuration information comprises a value in the group handover command that indicates one of the plurality of candidate dedicated configurations that is for the UE.

FIG. 20 illustrates a method 2000 of a source base station, according to embodiments herein. The method 2000 includes sending 2002 a PTM transmission to a plurality of UEs operating on a source serving cell of the source base station, the PTM transmission comprising common configuration information for operating on a target serving cell.

The method 2000 further includes sending 2004, to a first UE of the plurality of UEs, first dedicated configuration information for operating the first UE on the target serving cell.

The method 2000 further includes sending 2006, to a second UE of the plurality of UEs, second dedicated configuration information for operating the second UE on the target serving cell.

In some embodiments of the method 2000, the target serving cell is a cell of a target base station, and the method 2000 further includes receiving, from the target base station, a common configuration for the target serving cell, wherein the common configuration for the target serving cell comprises the common configuration information for operating on the target serving cell.

In some embodiments, the method 2000 further includes receiving feedback signaling from the first UE in response to sending the common configuration information. In some such embodiments, the feedback signaling comprises a dedicated L3 RRCReconfigurationComplete message. In some such embodiments, the feedback signaling comprises L2 RLC ACK feedback. In some such embodiments, the feedback signaling comprises L1 HARQ-ACK signaling. In some such embodiments, the feedback signaling comprises a MAC CE.

In some embodiments of the method 2000, the PTM transmission comprises an RRCReconfiguration message having the common configuration information that is sent on an existing SRB.

In some embodiments, the method 2000 further includes establishing a new SRB for communication with the plurality of UEs, wherein the PTM transmission comprises a RRC message having the common configuration information that is sent on the new SRB.

In some embodiments of the method 2000, the PTM transmission uses a G-RNTI corresponding to a UE group that comprises the plurality of UEs.

In some embodiments, the method 2000 further includes encrypting the PTM transmission for use with a group ciphering key at the plurality of UEs and a group integrity protection key at the plurality of UEs.

In some embodiments of the method 2000, the PTM transmission further comprises a MAC-I for respective ones of the plurality of UEs for use with dedicated integrity protection keys at the respective ones of the plurality of UEs.

In some embodiments of the method 2000, the common configuration information comprises difference configuration information relative to a common configuration for the source serving cell. In some such embodiments, the method 2000 further includes sending, to a target base station for the target serving cell, a common configuration for operating on the source serving cell, and receiving, from the target base station, the difference configuration information. In some such embodiments, the method 2000 includes sending, to a target base station for the target serving cell, a request for a common configuration for the target serving cell, receiving, from the target base station, the common configuration for the target serving cell, and determining, based on the common configuration for the target serving cell, the difference configuration information.

In some embodiments of the method 2000, the first dedicated configuration information comprises a dedicated configuration for the first UE.

In some embodiments of the method 2000, the PTM transmission further includes a plurality of candidate dedicated configurations, and the first dedicated configuration information comprises an index corresponding to one of the plurality of candidate dedicated configurations that is for the UE.

In some embodiments of the method 2000, the first dedicated configuration information is sent in a first dedicated handover command and the second dedicated configuration information is sent in a second dedicated handover command. In some such embodiments, the first dedicated handover command comprises a conditional handover command.

In some embodiments of the method 2000, the PTM transmission further includes a plurality of candidate dedicated configurations, the first dedicated configuration information and the second dedicated configuration information are sent in a group handover command, the first dedicated configuration information comprises a first value in the group handover command that indicates one of the plurality of candidate dedicated configurations that is for the first UE, and the second dedicated configuration information comprises a second value in the group handover command that indicates one of the plurality of candidate dedicated configurations that is for the second UE.

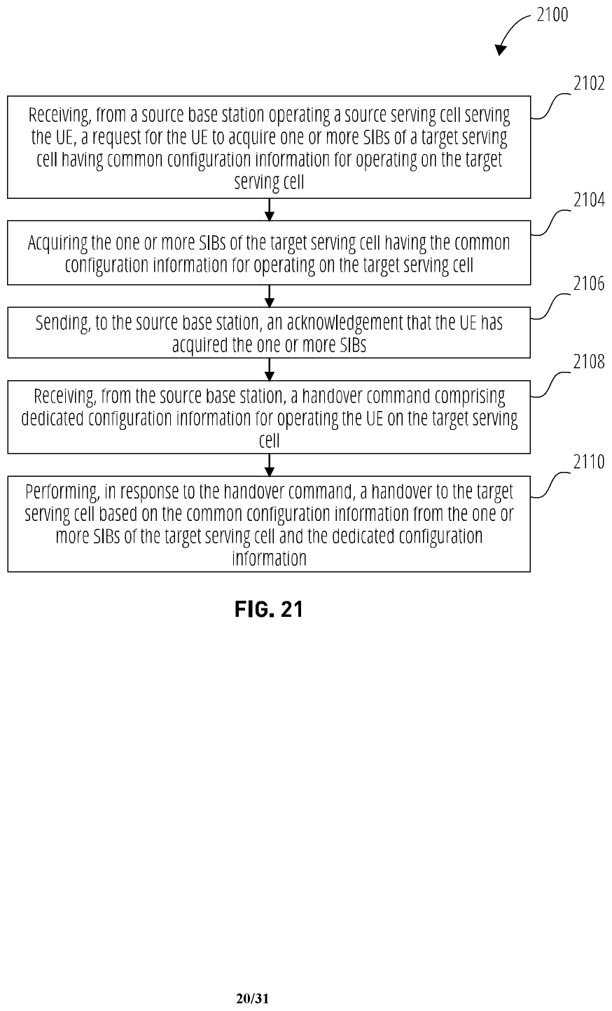

FIG. 21 illustrates a method 2100 of a UE, according to embodiments herein. The method 2100 includes receiving 2102 from a source base station operating a source serving cell serving the UE, a request for the UE to acquire one or more SIBs of a target serving cell having common configuration information for operating on the target serving cell.

The method 2100 further includes acquiring 2104 the one or more SIBs of the target serving cell having the common configuration information for operating on the target serving cell.

The method 2100 further includes sending 2106, to the source base station, an acknowledgement that the UE has acquired the one or more SIBs.

The method 2100 further includes receiving 2108, from the source base station, a handover command comprising dedicated configuration information for operating the UE on the target serving cell.

The method 2100 further includes performing 2110, in response to the handover command, a handover to the target serving cell based on the common configuration information from the one or more SIBs of the target serving cell and the dedicated configuration information.

In some embodiments of the method 2100, the request identifies the one or more SIBs of the target serving cell.

In some embodiments of the method 2100, the handover command comprises a conditional handover command.

In some embodiments of the method 2100, the request is carried in an SIB of the source serving cell.

In some embodiments of the method 2100, the request is carried in an RRC message.

In some embodiments of the method 2100, the request is carried in one of a L1 message and a L2 message.

In some embodiments, the method 2100 further includes sending, to the source base station, a UE capability message indicating that the UE is capable of acquiring the one or more SIBs prior to the handover.

In some embodiments of the method 2100, the dedicated configuration information comprises a dedicated configuration for the UE.

In some embodiments, the method 2100 further includes receiving, from the source base station, in a PTM transmission, a plurality of candidate dedicated configurations, and the dedicated configuration information comprises an index corresponding to one of the plurality of candidate dedicated configurations that is for the UE.

In some embodiments of the method 2100, the handover command comprises a dedicated handover command.

In some embodiments, the method 2100 further includes receiving, from the source base station, in a PTM transmission, a plurality of candidate dedicated configurations, wherein the handover command comprises a group handover command and the dedicated configuration information comprises a value in the group handover command that indicates one of the plurality of candidate dedicated configurations for the UE.

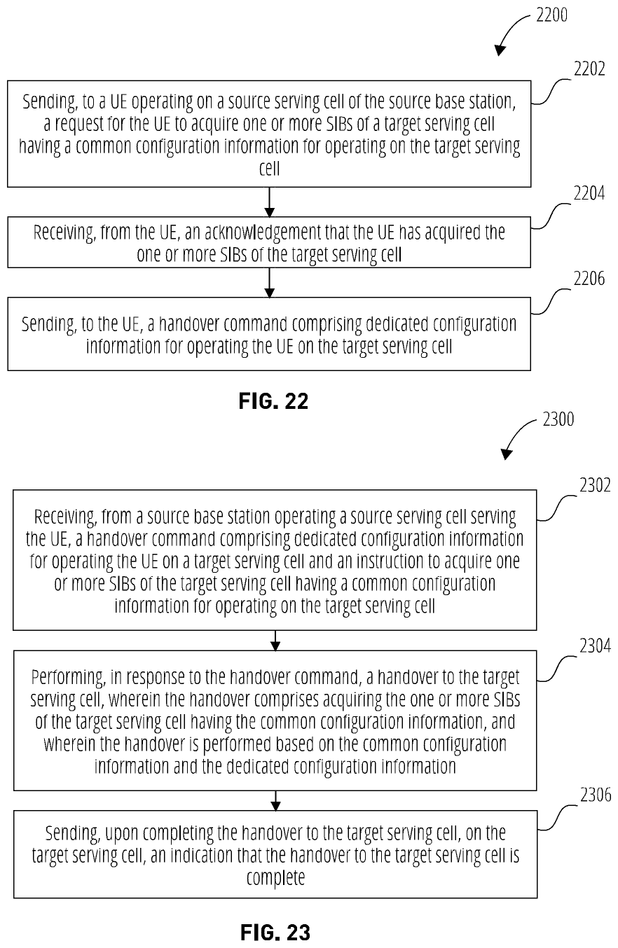

FIG. 22 illustrates a method 2200 of a source base station, according to embodiments herein. The method 2200 includes sending 2202, to a UE operating on a source serving cell of the source base station, a request for the UE to acquire one or more SIBs of a target serving cell having a common configuration information for operating on the target serving cell.

The method 2200 further includes receiving 2204, from the UE, an acknowledgement that the UE has acquired the one or more SIBs of the target serving cell.

The method 2200 further includes sending 2206s, to the UE, a handover command comprising dedicated configuration information for operating the UE on the target serving cell.

In some embodiments of the method 2200, the target serving cell is a cell of a target base station.

In some embodiments of the method 2200, the request identifies the one or more SIBs of the target serving cell.

In some embodiments of the method 2200, the handover command comprises a conditional handover command.

In some embodiments of the method 2200, the request is carried in an SIB of the source serving cell.

In some embodiments of the method 2200, the request is carried in an RRC message.

In some embodiments of the method 2200, the request is carried in one of an L1message and an L2 message.

In some embodiments, the method 2200 further includes receiving, from the UE, a UE capability message indicating that the UE is capable of acquiring the one or more SIBs prior to a handover.

In some embodiments of the method 2200, the dedicated configuration information comprises a dedicated configuration for the UE.

In some embodiments, the method 2200 further includes sending, to the UE, in a PTM transmission, a plurality of candidate dedicated configurations, and the dedicated configuration information comprises an index corresponding to one of the plurality of candidate dedicated configurations that is for the UE.

In some embodiments of the method 2200, the handover command comprises a dedicated handover command.

In some embodiments, the method 2200 further includes sending, to the UE, in a PTM transmission, a plurality of candidate dedicated configurations, wherein the handover command comprises a group handover command and the dedicated configuration information comprises a value in the group handover command that indicates one of the plurality of candidate dedicated configurations for the UE.

FIG. 23 illustrates a method 2300 of a UE, according to embodiments herein. The method 2300 includes receiving 2302, from a source base station operating a source serving cell serving the UE, a handover command comprising dedicated configuration information for operating the UE on a target serving cell and an instruction to acquire one or more SIBs of the target serving cell having a common configuration information for operating on the target serving cell.

The method 2300 further includes performing 2304, in response to the handover command, a handover to the target serving cell, wherein the handover comprises acquiring the one or more SIBs of the target serving cell having the common configuration information, and wherein the handover is performed based on the common configuration information and the dedicated configuration information.

The method 2300 further includes sending 2306, upon completing the handover to the target serving cell, on the target serving cell, an indication that the handover to the target serving cell is complete.

In some embodiments of the method 2300, the handover command identifies the one or more SIBs of the target serving cell.

In some embodiments of the method 2300, the handover command is comprises conditional handover command.

In some embodiments of the method 2300, the dedicated configuration information comprises a dedicated configuration for the UE.

In some embodiments, the method 2300 further includes receiving, from the source base station, in a PTM transmission, a plurality of candidate dedicated configurations, and wherein the dedicated configuration information comprises an index corresponding to one of the plurality of candidate dedicated configurations that is for the UE.

In some embodiments of the method 2300, the handover command comprises a dedicated handover command.

In some embodiments, the method 2300 further includes receiving, from the source base station, in a PTM transmission, a plurality of candidate dedicated configurations, wherein the handover command comprises a group handover command and the dedicated configuration information comprises a value in the group handover command that indicates one of the plurality of candidate dedicated configurations for the UE.

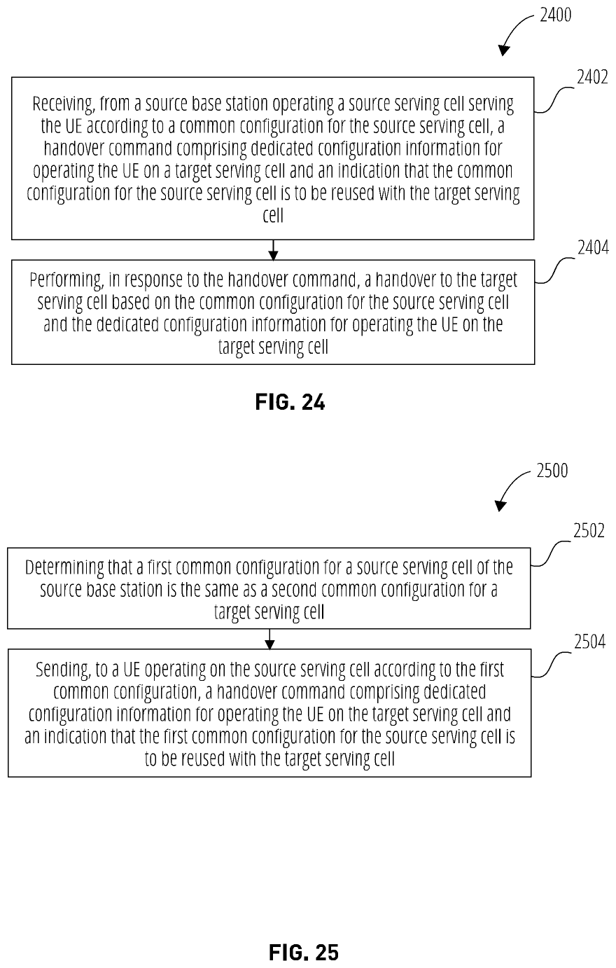

FIG. 24 illustrates a method 2400 of a UE, according to embodiments herein. The method 2400 includes receiving 2402, from a source base station operating a source serving cell serving the UE according to a common configuration for the source serving cell, a handover command comprising dedicated configuration information for operating the UE on a target serving cell and an indication that the common configuration for the source serving cell is to be reused with the target serving cell.

The method 2400 further includes performing 2404, in response to the handover command, a handover to the target serving cell based on the common configuration for the source serving cell and the dedicated configuration information for operating the UE on the target serving cell.

In some embodiments of the method 2400, the handover command further comprises an updated parameter for the common configuration for the source serving cell.

In some embodiments of the method 2400, the handover command comprises a conditional handover command.

In some embodiments of the method 2400, the dedicated configuration information comprises a dedicated configuration for the UE.

In some embodiments, the method 2400 further includes receiving, from the source base station, in a PTM transmission, a plurality of candidate dedicated configurations, and wherein the dedicated configuration information comprises an index corresponding to one of the plurality of candidate dedicated configurations that is for the UE.

In some embodiments of the method 2400, the handover command comprises a dedicated handover command.

In some embodiments, the method 2400 further includes receiving, from the source base station, in a PTM transmission, a plurality of candidate dedicated configurations, wherein the handover command comprises a group handover command and the dedicated configuration information comprises a value in the group handover command that indicates one of the plurality of candidate dedicated configurations for the UE.

FIG. 25 illustrates a method 2500 of a source base station, according to embodiments herein. The method 2500 includes determining 2502 that a first common configuration for a source serving cell of the source base station is the same as a second common configuration for a target serving cell.

The method 2500 further includes sending 2504, to a UE operating on the source serving cell according to the first common configuration, a handover command comprising dedicated configuration information for operating the UE on the target serving cell and an indication that the first common configuration for the source serving cell is to be reused with the target serving cell.

In some embodiments of the method 2500, the handover command further comprises an updated parameter for the first common configuration for the source serving cell.

In some embodiments of the method 2500, the handover command comprises a conditional handover command.

In some embodiments of the method 2500, the dedicated configuration information comprises a dedicated configuration for the UE In some embodiments, the method 2500 further includes sending, to the UE, in a PTM transmission, a plurality of candidate dedicated configurations, and wherein the dedicated configuration information comprises an index corresponding to one of the plurality of candidate dedicated configurations that is for the UE.

In some embodiments of the method 2500, the handover command comprises a dedicated handover command.

In some embodiments, the method 2500 further includes sending, to the UE, in a PTM transmission, a plurality of candidate dedicated configurations, wherein the handover command comprises a group handover command and the dedicated configuration information comprises a value in the group handover command that indicates one of the plurality of candidate dedicated configurations for the UE.

It may be that a target base station that operates a target serving cell delivers a common configuration for the target serving cell to the source base station. This enables the source base station to provide its UEs with common configuration information for operating on the target serving cell to its UEs (e.g., where this common configuration information may include the common configuration for the target serving cell and/or difference configuration information for the target serving cell that the source base station has determined by comparing the common configuration for the target serving cell to a common configuration for the source serving cell, etc.). Accordingly, systems and methods for communicating a common configuration between base stations on an Xn interface between the base stations may be used to facilitate this communication between a source base station and a target base station.

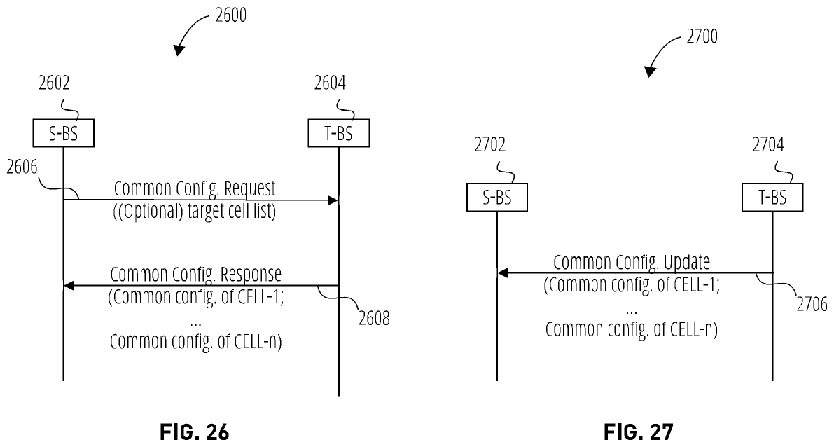

FIG. 26 illustrates a diagram 2600 for a first option for communicating a common configuration between a source base station and a target base station on an Xn interface, according to an embodiment. A source base station (labelled “S-BS” in the diagram 2600) 2602 may be operating a source serving cell and a target base station (labelled “T-BS” in the diagram 2600) 2604 may be operating a target serving cell, as is discussed in embodiments herein. The source base station 2602 sends 2606 a common configuration request to the target base station 2604. As illustrated, the common configuration request may optionally include a target cell list for target serving cell(s) for which the source base station 2602 is requesting a common configuration.

In response to the common configuration request, the target base station 2604 sends 2608 a common configuration response. As illustrated, the common configuration response includes one or more common configurations for one or more serving cells operated by the target base station 2604, which may include common configuration(s) for target serving cell(s) from the perspective of the source base station 2602. If a target cell list was provided in the common configuration request, the target base station 2604 may use it to determine for which of its serving cells to include a common configuration in the common configuration response.

FIG. 27 illustrates a diagram 2700 for a second option for communicating a common configuration between a source base station and a target base station on an Xn interface, according to an embodiment. A source base station (labelled “S-BS” in the diagram 2700) 2702 may be operating a source serving cell and a target base station (labelled “T-BS” in the diagram 2700) 2704 may be operating a target serving cell, as is discussed in embodiments herein. The target base station 2704 sends 2706 a common configuration update message that includes one or more common configurations for one or more serving cells operated by the target base station 2704 (one or more of which may be target serving cells from the perspective of the source base station 2702).

The common configuration update message may be sent by the target base station 2704 without any prior messaging directed to triggering this action being received from the source base station 2702.

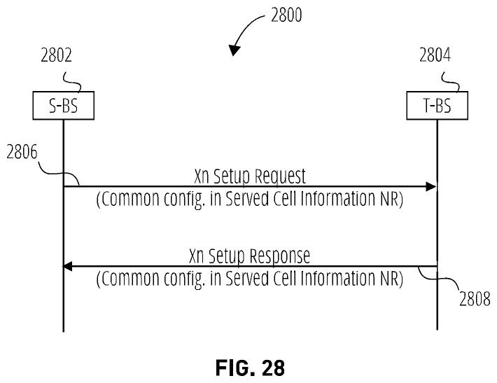

FIG. 28 illustrates a diagram 2800 for a third option for communicating a common configuration between a source base station and a target base station on an Xn interface, according to an embodiment. A source base station (labelled “S-BS” in the diagram 2800) 2802 may be operating a source serving cell and a target base station (labelled “T-BS” in the diagram 2800) 2804 may be operating a target serving cell, as is discussed in embodiments herein. The source base station 2802 sends 2806 an Xn initiatory message (e.g., the illustrated Xn setup request message) to the target base station 2804. The Xn initiatory message may include a request for one or more common configuration(s) for one or more target serving cell(s). The diagram 2800 illustrates that this request may take the form of an indication (“Common config.”) in a request for serving cell information from the target base station 2804 (“Served Cell Information NR”) in some embodiments.

In response to the Xn initiatory message, the target base station 2804 sends 2808 an Xn reply message (e.g., the illustrates Xn setup response message). The Xn reply message includes one or more common configurations for one or more serving cells operated by the target base station 2804, which may include common configuration(s) for target serving cell(s) from the perspective of the source base station 2802. The diagram 2800 illustrates that this response may take the form of responsive data (“Common config.”) in a larger overall set of data in response to the prior request for serving cell information (“Served Cell Information NR”) in some embodiments.

Examples of pairs of Xn initiatory messages and corresponding Xn reply messages that may be used corresponding to the discussion of the diagram 2800 include an Xn setup request message and an Xn setup response message, an NG-RAN node configuration update message and an NG-RAN node configuration update ACK, a cell activation request message and a cell activation response message, and a resource status request message and a resource status response message, etc.

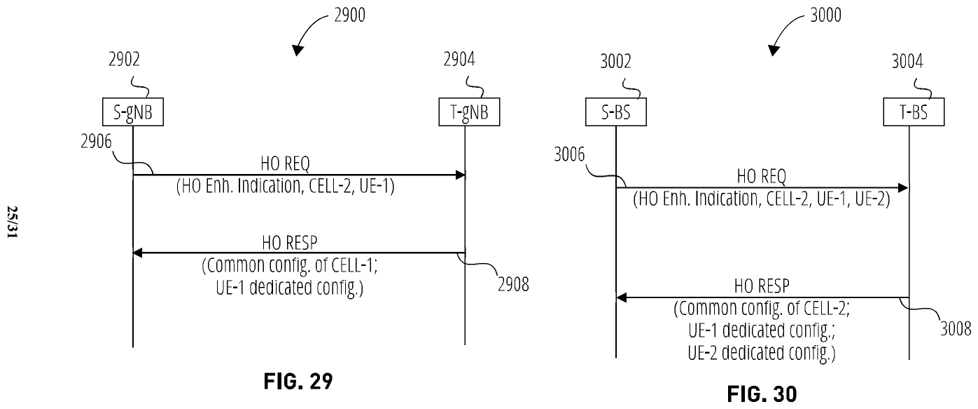

FIG. 29 illustrates a diagram 2900 for a fourth option for communicating a common configuration between a source base station and a target base station on an Xn interface, according to an embodiment. A source base station (labelled “S-BS” in the diagram 2900) 2902 may be operating a source serving cell and a target base station (labelled “T-BS” in the diagram 2900) 2904 may be operating a target serving cell, as is discussed in embodiments herein. The source base station 2902 sends 2906 a handover request (e.g., the illustrated HO REQ message) to the target base station 2904. The handover request indicates a target serving cell operated by the target base station (“CELL-2”) and a UE that is a subject of the handover request (“UE-1”).

In response to the handover request, the target base station 2904 sends 2908 a handover response (e.g., the illustrated HO RESP message). The handover response indicates a common configuration for the target serving cell (“Common config. of CELL-2”) and a dedicated configuration for the UE for operating on the target serving cell (“UE-1 dedicated config.”).

In cases there is no change between the common configuration for a target serving cell and a common configuration for the current serving cell of the UE, the source base station 2902 may include an indication of the same in the handover response rather than including the common configuration for the target serving cell in the handover response. Accordingly, it may be understood that such embodiments according to handover requests may use handover responses with common configuration information generally, and not necessarily with a specific common configuration itself.

FIG. 30 illustrates a diagram 3000 for a fifth option for communicating a common configuration between a source base station and a target base station, according to an embodiment. A source base station (labelled “S-BS” in the diagram 3000) 3002 may be operating a source serving cell and a target base station (labelled “T-BS” in the diagram 3000) 3004 may be operating a target serving cell, as is discussed in embodiments herein. The source base station 3002 sends 3006 a handover request (e.g., the illustrated HO REQ message) to the target base station 3004. The handover request indicates a target serving cell operated by the target base station (“CELL-2”) and multiple UEs that are the subject of the handover request (“UE-1”, “UE-2”).

In response to the handover request, the target source base station 3002 sends 3008 a handover response (e.g., the illustrated handover RESP message). The handover response indicates a common configuration for the target serving cell (“Common config. of CELL-2”) and a dedicated configuration for each of the UEs for operating on the target serving cell (“UE-1 dedicated config.,”“UE-2 dedicated config.”).

In cases there is no change between the common configuration for a target serving cell and a common configuration for the current serving cell of the UE, the source base station 2902 may include an indication of the same in the handover response rather than including the common configuration for the target serving cell in the handover response. Accordingly, it may be understood that such embodiments according to handover requests may use handover responses with common configuration information generally, and not necessarily with a specific common configuration itself.

In embodiments that divide base station functionality between a centralized unit (CU) and a distributed unit (DU) (e.g., in the case of integrated access and backhaul (IAB)), it may be that an F1 interface between the CU and the DU is used to communicate regarding a configuration of a group of UEs.

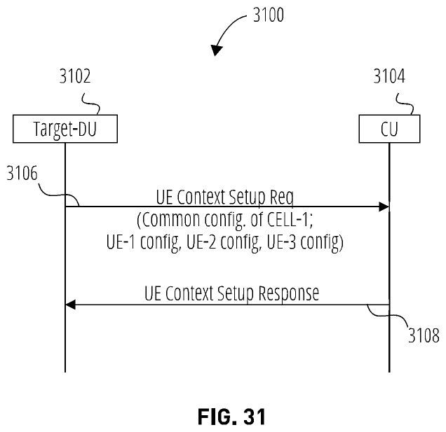

FIG. 31 illustrates a flow diagram 3100 for group-wise configuration for multiple UEs between a target-DU 3102 and a CU 3104 on an F1 interface, according to an embodiment. A DU sends 3106 a message to the CU 3104 comprising a common configuration for operating on a target serving cell and one or more dedicated configurations for corresponding one or more UEs for operating on the target serving cell. As illustrated, in some embodiments, this message may be a UE context setup request, with “common config. of CELL-1” representing the common configuration for operating on the target serving cell, “UE-1 dedicated config.” representing a dedicated configuration for a first UE, “UE-2 dedicated config.” representing a dedicated configuration for a second UE, and “UE-3 dedicated config.” representing a dedicated configuration for a third UE. In other embodiments, another message (other than a UE context setup request) may be used.

In response, the CU 3104 sends 3108, to the target-DU 3102, a message indicating that the common configuration and the one or more dedicated configurations were successfully received. As illustrated, in some embodiments (e.g., corresponding to the receipt of a UE context setup request), this message may be a UE context setup response message that indicates that a context for each of the UEs was successfully established at the CU based on the common configuration and the one or more dedicated configurations. In other embodiments, another message (other than a UE context setup request) may be used.

In some alternative cases, it may be that the CU initiates the procedure by sending a target-DU a message comprising a common configuration for operating on a target serving cell and one or more dedicated configurations for corresponding one or more UEs for operating on the target serving cell, and the target-DU then sends a message indicating that the common configuration and the one or more dedicated configurations were successfully received in response.

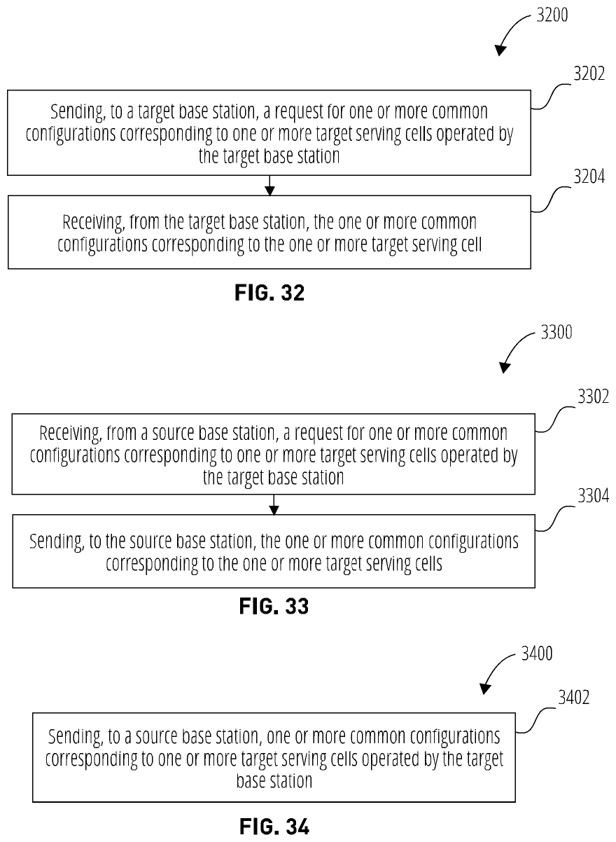

FIG. 32 illustrates a method 3200 of a source base station, according to embodiments herein. The method 3200 includes sending 3202, to a target base station, a request for one or more common configurations corresponding to one or more target serving cells operated by the target base station.

The method 3200 further includes receiving 3204, from the target base station, the one or more common configurations corresponding to the one or more target serving cell.

In some embodiments of the method 3200, the request identifies the one or more target serving cells.

FIG. 33 illustrates a method 3300 of a target base station, according to embodiments herein. The method 3300 includes receiving 3302, from a source base station, a request for one or more common configurations corresponding to one or more target serving cells operated by the target base station.

The method 3300 further includes sending 3304, to the source base station, the one or more common configurations corresponding to the one or more target serving cells.

In some embodiments of the method 3300, the request identifies the one or more target serving cells.

FIG. 34 illustrates a method 3400 of a source base station, according to embodiments herein. The method 3400 includes sending 3402, to a source base station, one or more common configurations corresponding to one or more target serving cells operated by the target base station.

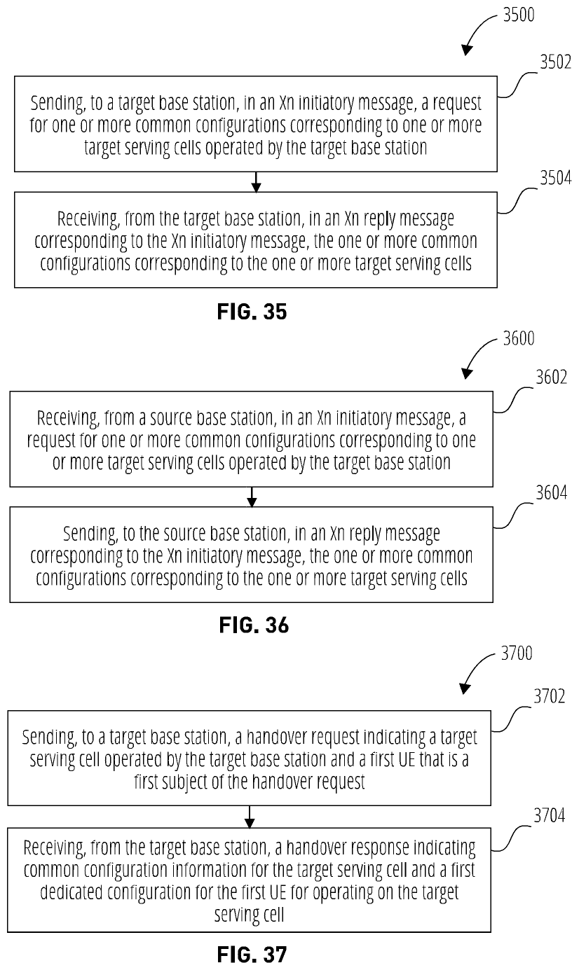

FIG. 35 illustrates a method 3500 of a source base station, according to embodiments herein. The method 3500 includes sending 3502, to a target base station, in an Xn initiatory message, a request for one or more common configurations corresponding to one or more target serving cells operated by the target base station.

The method 3500 further includes receiving 3504, from the target base station, in an Xn reply message corresponding to the Xn initiatory message, the one or more common configurations corresponding to the one or more target serving cells.

In some embodiments of the method 3500, the Xn initiatory message comprises an Xn setup request message, and wherein the Xn reply message comprises an Xn setup response message.

In some embodiments of the method 3500, the Xn initiatory message comprises a NG-RAN node configuration update message, and wherein the Xn reply message comprises an NG-RAN node configuration update ACK message.

In some embodiments of the method 3500, the Xn initiatory message comprises a cell activation request message, and wherein the Xn reply message comprises a cell activation response message.

In some embodiments of the method 3500, the Xn initiatory message comprises a resource status request message, and wherein the Xn reply message comprises a resource status response message.

FIG. 36 illustrates a method 3600 of a target base station, according to embodiments herein. The method 3600 includes receiving 3602, from a source base station, in an Xn initiatory message, a request for one or more common configurations corresponding to one or more target serving cells operated by the target base station.

The method 3600 further includes sending 3604, to the source base station, in an Xn reply message corresponding to the Xn initiatory message, the one or more common configurations corresponding to the one or more target serving cells.

In some embodiments of the 3600, the Xn initiatory message comprises an Xn setup request message, and wherein the Xn reply message comprises an Xn setup response message.

In some embodiments of the 3600, the Xn initiatory message comprises a NG-RAN node configuration update message, and wherein the Xn reply message comprises an NG-RAN node configuration update ACK message.

In some embodiments of the 3600, the Xn initiatory message comprises a cell activation request message, and wherein the Xn reply message comprises a cell activation response message.

In some embodiments of the 3600, the Xn initiatory message comprises a resource status request message, and wherein the Xn reply message comprises a resource status response message.

FIG. 37 illustrates a method 3700 of a source base station, according to embodiments herein. The method 3700 includes sending 3702, to a target base station, a handover request indicating a target serving cell operated by the target base station and a first UE that is a first subject of the handover request.

The method 3700 further includes receiving 3704, from the target base station, a handover response indicating common configuration information for the target serving cell and a first dedicated configuration for the first UE for operating on the target serving cell.

In some embodiments of the method 3700, the common configuration information comprises a common configuration for the target serving cell.

In some embodiments of the method 3700, the common configuration information comprises an indication that there is no change necessary between a first common configuration for the source serving cell and a second common configuration for the target serving cell.

In some embodiments of the method 3700, the handover request further indicates a second UE that is a second subject of the handover request, and wherein the handover response further indicates a second dedicated configuration for the second UE for operating on the target serving cell.

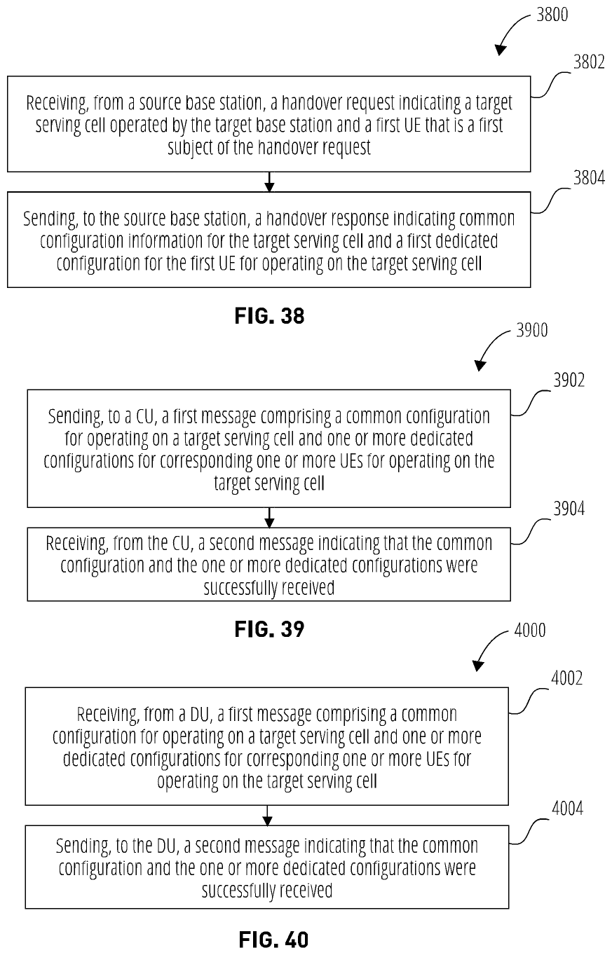

FIG. 38 illustrates a method 3800 of a target base station, according to embodiments herein. The method 3800 includes receiving 3802, from a source base station, a handover request indicating a target serving cell operated by the target base station and a first UE that is a first subject of the handover request.

The method 3800 further includes sending 3804, to the source base station, a handover response indicating common configuration information for the target serving cell and a first dedicated configuration for the first UE for operating on the target serving cell.

In some embodiments of the method 3800, the common configuration information comprises a common configuration for the target serving cell.

In some embodiments of the method 3800, the common configuration information comprises an indication that there is no change necessary between a first common configuration for the source serving cell and a second common configuration for the target serving cell.

In some embodiments of the method 3800, the handover request further indicates a second UE that is a second subject of the handover request, and wherein the handover response further indicates a second dedicated configuration for the second UE for operating on the target serving cell.

FIG. 39 illustrates a method 3900 of a DU, according to embodiments herein. The method 3900 includes sending 3902, to a CU, a first message comprising a common configuration for operating on a target serving cell and one or more dedicated configurations for corresponding one or more UEs for operating on the target serving cell.

The method 3900 further includes receiving 3904, from the CU, a second message indicating that the common configuration and the one or more dedicated configurations were successfully received.

In some embodiments of the method 3900, the first message comprises a UE context setup request, and the second message comprises a UE context setup response that indicates that a context for each of the one or more UEs was successfully established at the CU based on the common configuration and the one or more dedicated configurations.

FIG. 40 illustrates a method 4000 of a CU, according to embodiments herein. The method 4000 includes receiving 4002, from a DU, a first message comprising a common configuration for operating on a target serving cell and one or more dedicated configurations for corresponding one or more UEs for operating on the target serving cell.

The method 4000 further includes sending 4004, to the DU, a second message indicating that the common configuration and the one or more dedicated configurations were successfully received.

In some embodiments of the method 4000, the first message comprises a UE context setup request, and the second message comprises a UE context setup response that indicates that a context for each of the one or more UEs was successfully established at the CU based on the common configuration and the one or more dedicated configurations.

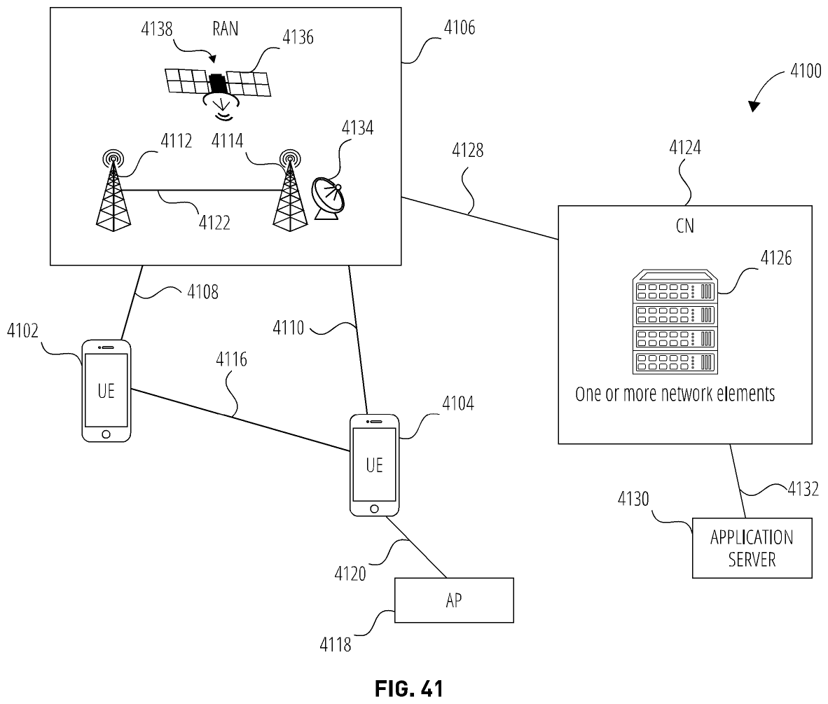

FIG. 41 illustrates an example architecture of a wireless communication system 4100, according to embodiments disclosed herein. The following description is provided for an example wireless communication system 4100 that operates in conjunction with the LTE system standards and/or 5G or NR system standards as provided by 3GPP technical specifications and other 3GPP documents.

As shown by FIG. 41, the wireless communication system 4100 includes UE 4102 and UE 4104 (although any number of UEs may be used). In this example, the UE 4102 and the UE 4104 are illustrated as smartphones (e.g., handheld touchscreen mobile computing devices connectable to one or more cellular networks), but may also comprise any mobile or non-mobile computing device configured for wireless communication.

The UE 4102 and UE 4104 may be configured to communicatively couple with a RAN 4106. In embodiments, the RAN 4106 may be NG-RAN, E-UTRAN, etc. The UE 4102 and UE 4104 utilize connections (or channels) (shown as connection 4108 and connection 4110, respectively) with the RAN 4106, each of which comprises a physical communications interface. The RAN 4106 can include one or more base stations (such as base station 4112 and the base station 4114) and/or other entities (e.g., a payload on the satellite 4136, which may operate a cell as directed by one of the base station 4112 and/or the base station 4114) that enable the connection 4108 and connection 4110. One or more non-terrestrial gateways 4134 may integrate the payload 4138 on the satellite 4136 into the RAN 4106, in the manner described in relation to the NTN architecture 100 of FIG. 1.

In this example, the connection 4108 and connection 4110 are air interfaces to enable such communicative coupling, and may be consistent with RAT(s) used by the RAN 4106, such as, for example, an LTE and/or NR. It is contemplated that the connection 4108 and connection 4110 may include, in some embodiments, service links between their respective UE 4102, UE 4104 and the payload 4138 of the satellite 4136.

In some embodiments, the UE 4102 and UE 4104 may also directly exchange communication data via a sidelink interface 4116.

The UE 4104 is shown to be configured to access an access point (AP) (shown as AP 4118) via connection 4120. By way of example, the connection 4120 can comprise a local wireless connection, such as a connection consistent with any IEEE 802.11 protocol, wherein the AP 4118 may comprise a Wi-Fi® router. In this example, the AP 4118 may be connected to another network (for example, the Internet) without going through a CN 4124.

In embodiments, the UE 4102 and UE 4104 can be configured to communicate using orthogonal frequency division multiplexing (OFDM) communication signals with each other, with the base station 4112, the base station 4114, and/or the payload 4138 of the satellite 4136 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 4112 and/or the base station 4114 may be implemented as one or more software entities running on server computers as part of a virtual network.

In addition, or in other embodiments, the base station 4112 or base station 4114 may be configured to communicate with one another via interface 4122. In embodiments where the wireless communication system 4100 is an LTE system (e.g., when the CN 4124 is an EPC), the interface 4122 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 4100 is an NR system (e.g., when CN 4124 is a 5GC), the interface 4122 may be an Xn interface. An Xn interface is defined between two or more base stations that connect to 5GC (e.g., CN 4124). For example, the Xn interface may be between two or more gNBs that connect to 5GC, a gNB connecting to 5GC and an eNB, between two eNBs connecting to 5GC.

In embodiments where the wireless communication system 4100 is an LTE system (e.g., when the CN 4124 is an EPC), the interface 4122 may be an X2 interface. The X2 interface may be defined between two or more base stations (e.g., two or more eNBs and the like) that connect to an EPC, and/or between two eNBs connecting to the EPC.

The RAN 4106 is shown to be communicatively coupled to the CN 4124. The CN 4124 may comprise one or more network elements 4126, which are configured to offer various data and telecommunications services to customers/subscribers (e.g., users of UE 4102 and UE 4104) who are connected to the CN 4124 via the RAN 4106. The components of the CN 4124 may be implemented in one physical device or separate physical devices including components to read and execute instructions from a machine-readable or computer-readable medium (e.g., a non-transitory machine-readable storage medium). For example, the components of the CN 4124 may be implemented in one or more processors and/or one or more associated memories.

In embodiments, the CN 4124 may be an EPC, and the RAN 4106 may be connected with the CN 4124 via an S1 interface 4128. In embodiments, the S1 interface 4128 may be split into two parts, an S1 user plane (S1-U) interface, which carries traffic data between the base station 4112, base station 4114, and a serving gateway (S-GW), and the S1-MME interface, which is a signaling interface between the base station 4112 and/or the base station 4114 and mobility management entities (MMEs).

In embodiments, the CN 4124 may be a 5GC, and the RAN 4106 may be connected with the CN 4124 via an NG interface 4128. In embodiments, the NG interface 4128 may be split into two parts, an NG user plane (NG-U) interface, which carries traffic data between the base station 4112 and/or base station 4114 and a user plane function (UPF), and the S1 control plane (NG-C) interface, which is a signaling interface between the base station 4112 and/or the base station 4114 and access and mobility management functions (AMFs).

Generally, an application server 4130 may be an element offering applications that use internet protocol (IP) bearer resources with the CN 4124 (e.g., packet switched data services). The application server 4130 can also be configured to support one or more communication services (e.g., VoIP sessions, group communication sessions, etc.) for the UE 4102 and UE 4104 via the CN 4124. The application server 4130 may communicate with the CN 4124 through an IP communications interface 4132.

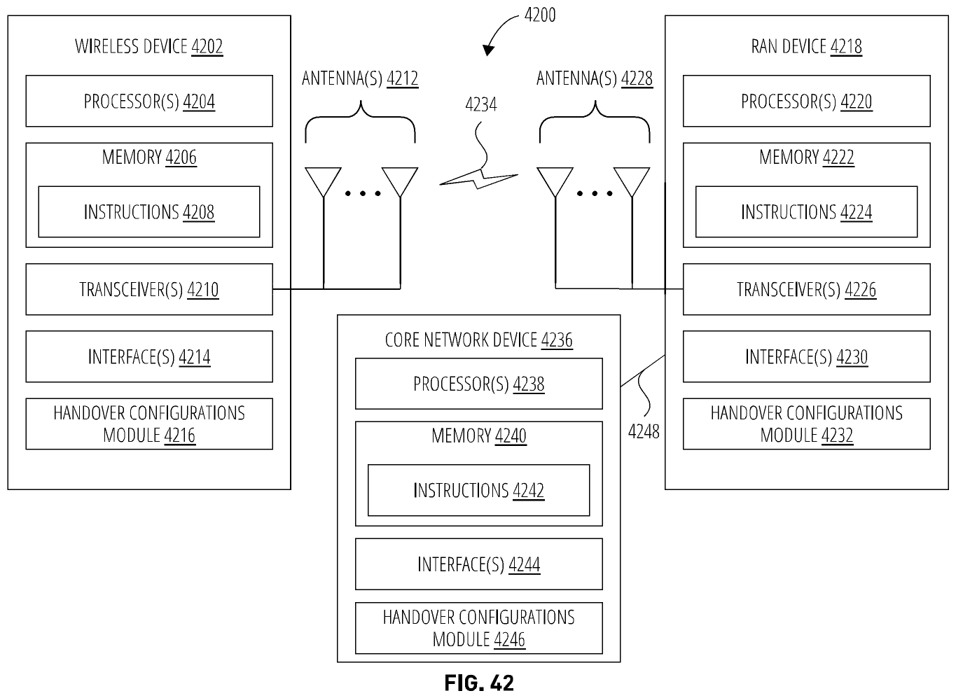

FIG. 42 illustrates a system 4200 for performing signaling 4234 between a wireless device 4202 and a RAN device 4218 connected to a core network of a CN device 4236, according to embodiments herein. The system 4200 may be a portion of a wireless communications system as herein described. The wireless device 4202 may be, for example, a UE of a wireless communication system. The RAN device 4218 may be, for example, a base station (e.g., an eNB or a gNB) of a wireless communication system that is a terrestrial base station. In the case of a RAN device 4218 that is a terrestrial base station, the RAN device 4218 may be in communication with a payload of a satellite that directly provides radio access connectivity to a UE, in the manner described herein. The CN device 4236 may be one or more devices making up a CN, as described herein.

The wireless device 4202 may include one or more processor(s) 4204. The processor(s) 4204 may execute instructions such that various operations of the wireless device 4202 are performed, as described herein. The processor(s) 4204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 4202 may include a memory 4206. The memory 4206 may be a non-transitory computer-readable storage medium that stores instructions 4208 (which may include, for example, the instructions being executed by the processor(s) 4204). The instructions 4208 may also be referred to as program code or a computer program. The memory 4206 may also store data used by, and results computed by, the processor(s) 4204.

The wireless device 4202 may include one or more transceiver(s) 4210 that may include RF transmitter and/or receiver circuitry that use the antenna(s) 4212 of the wireless device 4202 to facilitate signaling (e.g., the signaling 4234) to and/or from the wireless device 4202 with other devices (e.g., the RAN device 4218) according to corresponding RATs. In some embodiments, the antenna(s) 4212 may include a moving parabolic antenna, an omni-directional phased-array antenna, or some other antenna suitable for communication with a payload on a satellite, (e.g., as described above in relation to the UE 108 of FIG. 1).

In an NTN case, the network device signaling 4234 may occur on a service link between the wireless device 4202 and a payload on a satellite and a feeder link between the payload of the satellite and the RAN device 4218 (e.g., as described in relation to FIG. 1).

The wireless device 4202 may include one or more antenna(s) 4212 (e.g., one, two, four, or more). For embodiments with multiple antenna(s) 4212, the wireless device 4202 may leverage the spatial diversity of such multiple antenna(s) 4212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 4202 may be accomplished according to precoding (or digital beamforming) that is applied at the wireless device 4202 that multiplexes the data streams across the antenna(s) 4212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 4202 may implement analog beamforming techniques, whereby phases of the signals sent by the antenna(s) 4212 are relatively adjusted such that the (joint) transmission of the antenna(s) 4212 can be directed (this is sometimes referred to as beam steering).

The wireless device 4202 may include one or more interface(s) 4214. The interface(s) 4214 may be used to provide input to or output from the wireless device 4202. For example, a wireless device 4202 that is a UE may include interface(s) 4214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 4210/antenna(s) 4212 already described) that allow for communication between the UE and other devices and may operate according to known protocols (e.g., Wi-Fi®, Bluetooth®, and the like).

The wireless device 4202 may include a handover configurations module 4216. The handover configurations module 4216 may be implemented via hardware, software, or combinations thereof. For example, the handover configurations module 4216 may be implemented as a processor, circuit, and/or instructions 4208 stored in the memory 4206 and executed by the processor(s) 4204. In some examples, the handover configurations module 4216 may be integrated within the processor(s) 4204 and/or the transceiver(s) 4210. For example, the handover configurations module 4216 may be implemented by a combination of software components (e.g., executed by a DSP or a general processor) and hardware components (e.g., logic gates and circuitry) within the processor(s) 4204 or the transceiver(s) 4210.

The handover configurations module 4216 may be used for various aspects of the present disclosure, for example, aspects of FIG. 1 through FIG. 25. The handover configurations module 4216 is configured to, for example, receive common configuration information and/or dedicated configuration information from a base station (e.g., a RAN device 4218 that is a base station).

The RAN device 4218 may include one or more processor(s) 4220. The processor(s) 4220 may execute instructions such that various operations of the RAN device 4218 are performed, as described herein. The processor(s) 4204 may include one or more baseband processors implemented using, for example, a CPU, a DSP, an ASIC, a controller, an FPGA device, another hardware device, a firmware device, or any combination thereof configured to perform the operations described herein.

The RAN device 4218 may include a memory 4222. The memory 4222 may be a non-transitory computer-readable storage medium that stores instructions 4224 (which may include, for example, the instructions being executed by the processor(s) 4220). The instructions 4224 may also be referred to as program code or a computer program. The memory 4222 may also store data used by, and results computed by, the processor(s) 4220.

The RAN device 4218 may include one or more transceiver(s) 4226 that may include RF transmitter and/or receiver circuitry that use the antenna(s) 4228 of the RAN device 4218 to facilitate signaling (e.g., the signaling 4234) to and/or from the RAN device 4218 with other devices (e.g., the wireless device 4202) according to corresponding RATs.

The RAN device 4218 may include one or more antenna(s) 4228 (e.g., one, two, four, or more). In embodiments having multiple antenna(s) 4228, the RAN device 4218 may perform MIMO, digital beamforming, analog beamforming, beam steering, etc., as has been described.

In an NTN case, the transceiver(s) 4226 and the antenna(s) 4228 may alternatively be present on a payload of a satellite associated with the base station.

The RAN device 4218 may include one or more interface(s) 4230. The interface(s) 4230 may be used to provide input to or output from the RAN device 4218. For example, a RAN device 4218 that is a base station may include interface(s) 4230 made up of transmitters, receivers, and other circuitry (e.g., other than the transceiver(s) 4226/antenna(s) 4228 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 4218 may include a handover configurations module 4232. The handover configurations module 4232 may be implemented via hardware, software, or combinations thereof. For example, the handover configurations module 4232 may be implemented as a processor, circuit, and/or instructions 4224 stored in the memory 4222 and executed by the processor(s) 4220. In some examples, the handover configurations module 4232 may be integrated within the processor(s) 4220 and/or the transceiver(s) 4226. For example, the handover configurations module 4232 may be implemented by a combination of software components (e.g., executed by a DSP or a general processor) and hardware components (e.g., logic gates and circuitry) within the processor(s) 4220 or the transceiver(s) 4226.

The handover configurations module 4232 may be used for various aspects of the present disclosure, for example, aspects of FIG. 1. through FIG. 40. The handover configurations module 4232 is configured to, for example, send common configuration information and/or dedicated configuration information to a UE (e.g., a wireless device 4202 that is a UE), receive common configuration information from a target base station (e.g., another instance of RAN device 4218 that is a target base station) on an Xn interface, and/or send common configuration information to a source base station (e.g., another instance of RAN device 4218 target that is a source base station) on an Xn interface. Further, in the case that the RAN wireless device 4202 includes a DU and/or a CU, the handover configurations module 4232 may operate to handle the transmission of handover configuration related information between the CU and the DU on an F1 interface.

The RAN device 4218 may communicate with the CN device 4236 via the interface 4248, which may be analogous to the interface 4128 of FIG. 41 (e.g., may be an S1 and/or NG interface, either of which may be split into user plane and control plane parts).

The CN device 4236 may include one or more processor(s) 4238. The processor(s) 4238 may execute instructions such that various operations of the CN device 4236 are performed, as described herein. The processor(s) 4238 may include one or more baseband processors implemented using, for example, a CPU, a DSP, an ASIC, a controller, an FPGA device, another hardware device, a firmware device, or any combination thereof configured to perform the operations described herein.

The CN device 4236 may include a memory 4240. The memory 4240 may be a non-transitory computer-readable storage medium that stores instructions 4242 (which may include, for example, the instructions being executed by the processor(s) 4238). The instructions 4242 may also be referred to as program code or a computer program. The memory 4240 may also store data used by, and results computed by, the processor(s) 4238.

The CN device 4236 may include one or more interface(s) 4244. The interface(s) 4244 may be used to provide input to or output from the CN device 4236. For example, a CN device 4236 may include interface(s) 4230 made up of transmitters, receivers, and other circuitry that enables the CN device 4236 to communicate with other equipment in the CN, and/or that enables the CN device 4236 to communicate with external networks, computers, databases, and the like for purposes of operations, administration, and maintenance of the CN device 4236 or other equipment operably connected thereto.

The CN device 4236 may include a handover configurations module 4246. The handover configurations module 4246 may be implemented via hardware, software, or combinations thereof. For example, the handover configurations module 4246 may be implemented as a processor, circuit, and/or instructions 4242 stored in the memory 4240 and executed by the processor(s) 4238. In some examples, the handover configurations module 4246 may be integrated within the processor(s) 4238. For example, the handover configurations module 4246 may be implemented by a combination of software components (e.g., executed by a DSP or a general processor) and hardware components (e.g., logic gates and circuitry) within the processor(s) 4238.

The handover configurations module 4246 may be used for various aspects of the present disclosure, for example, aspects of FIG. 1. through FIG. 40. The handover configurations module 4246 is configured to, for example, configure the RAN device 4218 to use the handover configurations module 4232 of the RAN device 4218 in the manner described.

Embodiments contemplated herein include an apparatus comprising means to perform one or more elements of any of the method 1900, the method 2100, the method 2300, and/or the method 2400. This apparatus may be, for example, an apparatus of a UE (such as a wireless device 4202 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 1900, the method 2100, the method 2300, and/or the method 2400. This non-transitory computer-readable media may be, for example, a memory of a UE (such as a memory 4206 of a wireless device 4202 that is a UE, as described herein).

Embodiments contemplated herein include an apparatus comprising logic, modules, or circuitry to perform one or more elements of any of the method 1900, the method 2100, the method 2300, and/or the method 2400. This apparatus may be, for example, an apparatus of a UE (such as a wireless device 4202 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 1900, the method 2100, the method 2300, and/or the method 2400. This apparatus may be, for example, an apparatus of a UE (such as a wireless device 4202 that is a UE, as described herein).

Embodiments contemplated herein include a signal as described in or related to one or more elements of any of the method 1900, the method 2100, the method 2300, and/or the method 2400.

Embodiments contemplated herein include a computer program or computer program product comprising instructions, wherein execution of the program by a processor is to cause the processor to carry out one or more elements of any of the method 1900, the method 2100, the method 2300, and/or the method 2400. The processor may be a processor of a UE (such as a processor(s) 4204 of a wireless device 4202 that is a UE, as described herein). These instructions may be, for example, located in the processor and/or on a memory of the UE (such as a memory 4206 of a wireless device 4202 that is a UE, as described herein).

Embodiments contemplated herein include an apparatus comprising means to perform one or more elements of any of the method 2000, the method 2200, the method 2500, the method 3200, the method 3300, the method 3400, the method 3500, the method 3600, the method 3700, the method 3800, and/or the method 3900. This apparatus may be, for example, an apparatus of a base station (such as a RAN device 4218 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 2000, the method 2200, the method 2500, the method 3200, the method 3300, the method 3400, the method 3500, the method 3600, the method 3700, the method 3800, and/or the method 3900. This non-transitory computer-readable media may be, for example, a memory of a base station (such as a memory 4222 of a RAN device 4218 that is a base station, as described herein).

Embodiments contemplated herein include an apparatus comprising logic, modules, or circuitry to perform one or more elements of any of the method 2000, the method 2200, the method 2500, the method 3200, the method 3300, the method 3400, the method 3500, the method 3600, the method 3700, the method 3800, and/or the method 3900. This apparatus may be, for example, an apparatus of a base station (such as a RAN device 4218 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 2000, the method 2200, the method 2500, the method 3200, the method 3300, the method 3400, the method 3500, the method 3600, the method 3700, the method 3800, and/or the method 3900. This apparatus may be, for example, an apparatus of a base station (such as a RAN device 4218 that is a base station, as described herein).

Embodiments contemplated herein include a signal as described in or related to one or more elements of any of the method 2000, the method 2200, the method 2500, the method 3200, the method 3300, the method 3400, the method 3500, the method 3600, the method 3700, the method 3800, and/or the method 3900.

Embodiments contemplated herein include a computer program or computer program product comprising instructions, wherein execution of the program by a processing element is to cause the processing element to carry out one or more elements of any of the method 2000, the method 2200, the method 2500, the method 3200, the method 3300, the method 3400, the method 3500, the method 3600, the method 3700, the method 3800, and/or the method 3900. The processor may be a processor of a base station (such as a processor(s) 4220 of a RAN device 4218 that is a base station, as described herein). These instructions may be, for example, located in the processor and/or on a memory of the base station (such as a memory 4222 of a RAN device 4218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a source base station operating a source serving cell serving the UE, a point-to-multipoint (PTM) transmission comprising common configuration information for operating on a target serving cell;
receiving, from the source base station, dedicated configuration information for operating the UE on the target serving cell; and
performing a handover to the target serving cell using based on the common configuration information and the dedicated configuration information.

2. The method of claim 1, wherein the target serving cell is a cell of a target base station.

3. The method of claim 1, further comprising sending feedback signaling to the source base station in response to receiving the common configuration information.

4. The method of claim 3, wherein the feedback signaling comprises a dedicated layer 3 (L3) RRCReconfigurationComplete message.

5. The method of claim 3, wherein the feedback signaling comprises layer 2 (L2) radio link control (RLC) acknowledgement (ACK) feedback.

6. The method of claim 3, wherein the feedback signaling comprises layer 1 (L1) hybrid automatic repeat request acknowledgement (HARQ-ACK) signaling.

7. The method of claim 3, wherein the feedback signaling comprises a medium access control control element (MAC CE).

8. The method of claim 1, wherein the PTM transmission comprises an RRCReconfiguration message having the common configuration information that is received on an existing signaling radio bearer (SRB).

9. The method of claim 1, wherein the PTM transmission comprises a radio resource control (RRC) message having the common configuration information that is received on a newly established signaling radio bearer (SRB).

10. The method of claim 1, wherein the PTM transmission uses a group radio network temporary identifier (G-RNTI) of the UE that corresponds to a UE group that comprises the UE.

11. The method of claim 1, further comprising decrypting the PTM transmission with a group ciphering key and a group integrity protection key.

12. The method of claim 1, further comprising verifying an integrity of the PTM transmission by using a dedicated integrity protection key with the PTM transmission to match a message authentication code for integrity (MAC-I) for the UE included in the PTM transmission.

13. The method of claim 1, wherein the common configuration information comprises difference configuration information relative to a common configuration for the source serving cell.

14. The method of claim 1, wherein the dedicated configuration information comprises a dedicated configuration for the UE.

15. The method of claim 1, wherein the PTM transmission further includes a plurality of candidate dedicated configurations, and wherein the dedicated configuration information comprises an index corresponding to one of the candidate dedicated configurations for the UE.

16. The method of claim 1, wherein the dedicated configuration information is sent in a dedicated handover command.

17. The method of claim 16, wherein the dedicated handover command comprises a conditional handover command.

18. The method of claim 1, wherein:
the PTM transmission further includes a plurality of candidate dedicated configurations;
the dedicated configuration information is sent in a group handover command; and
the dedicated configuration information comprises a value in the group handover command that indicates one of the plurality of candidate dedicated configurations that is for the UE.

19. A method of a source base station, comprising:
sending a point-to-multipoint (PTM) transmission to a plurality of user equipments (UEs) operating on a source serving cell of the source base station, the PTM transmission comprising common configuration information for operating on a target serving cell;
sending, to a first UE of the plurality of UEs, first dedicated configuration information for operating the first UE on the target serving cell; and
sending, to a second UE of the plurality of UEs, second dedicated configuration information for operating the second UE on the target serving cell.

20. The method of claim 19, wherein the target serving cell is a cell of a target base station, and further comprising receiving, from the target base station, a common configuration for the target serving cell, wherein the common configuration for the target serving cell comprises the common configuration information for operating on the target serving cell.

21-41. (canceled)
